(19) United States
(12) Patent Application Publication
(10) Pub. No.: US 2026/0350603 A1
(43) Pub. Date: Nov. 5, 2026

(54) BILATERAL TRUSTWORTHINESS REPUTATION RATINGS FOR CRYPTO-WALLETS, AUTOMATED DISPUTE RESOLUTION AND TRUSTWORTHINESS RATINGS FOR DIGITAL WALLETS AND CRYPTO-WALLETS

(71) Applicants: Michael ONGHAI, Phoenix, AZ (US); Jun Tao He, Brooklyn, NY (US); Matthew Onghai, San Antonio, TX (US); Kyle Onghai, Port Jefferson, NY (US)

(72) Inventors: Michael ONGHAI, Phoenix, AZ (US); Jun Tao He, Brooklyn, NY (US); Matthew Onghai, San Antonio, TX (US); Kyle Onghai, Port Jefferson, NY (US)

(21) Appl. No.: 19/733,422

(22) Filed: Jul. 7, 2026

Related U.S. Application Data
(63) Continuation of application No. PCT/IB2025/050160, filed on Jan. 7, 2025.
(60) Provisional application No. 63/618,918, filed on Jan. 9, 2024.
(60) Provisional application No. 63/553,242, filed on Feb. 14, 2024.

(51) Int. Cl. G06Q 20/38; G06Q 20/40

(52) U.S. Cl. CPC G06Q 20/389; G06Q 20/401

(57) ABSTRACT

A widget or web site is configured, for each purchase between the buyer and the seller, to prompt each party to post transactions and input on the distributed ledger number-mappable ratings of the other's performance during the purchase. Processor(s) generate automated numerical ratings of each party based on each side's deadline compliance and determine after each purchase, an overall current reputation rating of the seller and the buyer based on the number-mappable ratings and/or the automated numerical ratings after an extraction program extracts these from multiple invoices on the ledger and the processor(s) aggregates them. Upon a dispute, processor(s) compare the overall current reputation rating of the parties, and generate an automated resolution of a disputed amount by automatically adjusting on the distributed ledger an account of the particular buyer and/or of the particular seller, the adjustment reflecting a share of the disputed amount in crypto-currency based on the comparison.

### FIELD OF THE INVENTION

The invention is in the field of crypto-wallets (and digital wallets) and pertains to their trustworthiness, for example a method and system of bilateral reputation ratings of the crypto-wallet, i.e. ratings of the crypto-wallet by a buyer who uses the crypto-wallet and ratings by a seller (who own the crypto-wallet) of the buyer who uses the crypto-wallet, and in some embodiments using the ratings for dispute resolution.

### BACKGROUND OF THE INVENTION

There are many web sites or companies that offer a wide range of different services. For example Fiverr is a digital marketplace for any kind of services requiring talent. People and businesses build their reputations based on reviews or ratings that customers provide.

The digital universe, where services are often provided to users without person-to-person contact and often recommendations or reviews by third parties are often provided other than in person, is prone to fraud, scams and disappointment. Besides the potential fraud of the reviewer, the business itself may not provide the services it claims to provide, or it may provide such services poorly despite good recommendations. The buyer may also not be willing to pay for the goods or services (which was delivered or not delivered as the case may be).

Although businesses build their reputations based in part on reviews by their customers, these reviews are often subjective. Further, the reviews are standard and monolithic.

Crypto-wallets, as a form of online payment, have become much more common.

A business may utilize multiple wallets for payments. For example, a dishonest business may utilize two different wallets, one for legitimate services and one for scamming the public. The fact that prospective customers of this business have available to them business reviews of the business would not prevent this fraudulent arrangement since many of the reviews of the business would still be favorable and the prospective customer's suspicions may be mollified by the favorable reviews.

A recent Jul. 19, 2023 article by Sam Brown of Clifford Chance entitled “Arbitration of cryptoasset and smart contract disputes: arbitration unchained?” discusses the unique aspects of resolving disputes arising from use of cryptocurrencies. Besides the problems of jurisdiction, forum selection and choice of law, the article discusses various attempts to develop arbitration tailored to cryptocurrency purchases such as (a) on-chain arbitration, in which traditional arbitration awards are enforced automatically by a smart contract of a blockchain, (b) multi-signature purchases in which a neutral party decides whether a transfer of payment using the crypto-wallet should take place and (c) oracles, where data from an external data source (for example data from a courier company) is used to decide whether goods were delivered.

Attempts have been made to develop dedicated arbitration standards.

### SUMMARY OF THE EMBODIMENTS

Applicant has found that cryptocurrency purchases are naturally less trustworthy because they are typically used for anonymous or semi-anonymous purchases. Although attempts have been made to develop dedicated arbitration standards or other techniques for this burgeoning field, this problem still remains.

One embodiment is a method of using bilateral ratings on distributed ledgers to establish reliable reputations and resolve disputes automatically, comprising: for each purchase of goods or services, using a widget or a web site to allow a buyer and a seller to interact with one another by posting transactions on a distributed ledger, one or more of the transactions include deadlines relating to the purchase, for each purchase, one or more of: (A) using the widget or the web site to provide number-mappable ratings by the buyer of the seller and by the seller of the buyer regarding the purchase that are transmitted to the distributed ledger for storage thereon by (i) one or more processors and/or by (ii) the widget or the web site and (B) generating automated numerical ratings by the one or more processors based on the seller's and the buyer's compliance with the deadlines stated in the posted transactions, extracting, by an extraction program, the number-mappable ratings and/or the automated numerical ratings from multiple invoices on the distributed ledger, and using, by the one or more processors, the number-mappable ratings in aggregate and/or the automated numerical ratings in aggregate to generate overall current reputation ratings for the buyer and for the seller that are accessible by the widget or the web site and updateable after each purchase; and upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

In some embodiments, the method further comprises rewarding, by the one or more processors, the particular buyer with a higher share of the disputed amount than the particular seller if the particular buyer has a higher overall current reputation rating than the particular seller.

In some embodiments, the method further comprises using, by the one or more processors, a ratio of (i) the overall current reputation rating of the particular buyer to (ii) the overall current reputation rating of the particular seller, to determine an amount of the adjustment.

In some embodiments, the method further comprises adjusting upward, by the one or more processors, a portion of the amount disputed awarded to the seller or to the buyer based on the relative overall current reputation rating between the buyer and the seller.

In some embodiments, the method further comprises for each purchase both (A) using the widget or the web site to provide number-mappable ratings by the buyer of the seller and by the seller of the buyer regarding the purchase that are transmitted to the distributed ledger for storage thereon by (i) the one or more processors or by (ii) the widget or the web site and (B) generating the automated numerical ratings by the one or more processors. In some embodiments, the method further comprises prompting the seller and/or the buyer to select whether the extraction program extracts the number-mappable ratings, the automated numerical ratings or both the number-mappable ratings and the automated numerical ratings. In some embodiments, the method further comprises extracting both the number-mappable ratings and the automated ratings and using the web site or the widget to display a version of the overall current reputation ratings of the buyer and/or seller based on the number-mappable ratings, a version based the automated ratings and a version based on both the number-mappable ratings and the automated ratings, wherein the buyer and/or the seller is prompted to select one of the three versions for purposes of the automated resolution of the amount in dispute.

In some embodiments, the one or more processors are configured to either (i) give less weight to number-mappable ratings of the buyer rating the seller as to a first purchase compared to the buyer rating the seller on a subsequent purchase or to (ii) give more weight to number-mappable ratings of the buyer rating the seller as to the first purchase compared to the buyer rating the seller on the subsequent purchase.

In some embodiments, the one or more processors are configured to either (i) give less weight to number-mappable ratings of the seller rating the buyer as to a first purchase compared to the seller rating the buyer on a subsequent purchase or to (ii) give more weight to number-mappable ratings of the seller rating the buyer as to the first purchase compared to the seller rating the buyer on the subsequent purchase.

In some embodiments, the automated numerical ratings of the seller are also based on whether and how soon the buyer accepted the goods or services.

In some embodiments, the method further comprises storing, by (i) the one or more processors and/or (ii) the widget or the web site, on the distributed ledger by invoice ID a purchase price and description of the purchased goods or services and the identity of the buyer and the seller.

In some embodiments, a text of the buyer's rating of the seller is recorded for the purchase on the distributed ledger along with the number-mappable rating. In some embodiments, the widget or the extraction program is configured to retrieve the text from the distributed ledger and display it on the widget or web site.

In some embodiments, the method further comprises automatically escrowing, by the one or more processors, funds of the buyer in an amount of a price of the purchase on the distributed ledger pending delivery by the seller.

In some embodiments, if the buyer or the seller lodge a dispute of the purchase, the one or more processors automatically penalize both the buyer and the seller in future calculations of one or both of automated numerical ratings and the overall current reputation ratings.

In some embodiments, the method further comprises using the widget or a web site controlled by the one or more processors, the web site interacting with the distributed ledger, to post a confirmation on the distributed ledger of one or more of the following:
(a) the seller presents the buyer with an invoice including a timeframe for the buyer to approve delivery, and including a negotiation timeframe, wherein the buyer inputting approval on the widget or the web site triggers the one or more processors to record and hold an amount of the purchase price in crypto-currency in escrow on the distributed ledger pending the seller posting that delivery occurred,
(b) the seller declares delivery, failure of which results in reversal of the amount of the escrowed crypto-currency funds and the overall current reputation rating of the seller automatically reduced for inability to deliver on time,
(c) the seller requests a specific amount of more time to deliver, failure of which by the buyer to approve results in a resolution similar to the seller's failure to deliver,
(d) the buyer has a duration of the negotiation timeframe to accept delivery or if the buyer finds the deliverables to be inadequate,
(e) if the buyer does not respond to the delivery within the negotiation timeframe, the one or more processors mark the invoice as delivered on the distributed ledger and the amount held in escrow is released to the seller.

In some embodiments, the method further comprises reducing, by the one or more processors, the overall current reputation rating of the buyer if the buyer does not respond to the delivery within the negotiation timeframe.

Another embodiment is a system of using bilateral ratings of buyers and sellers on distributed ledgers to establish reliable reputations and resolve disputes automatically, comprising:
a widget or a web site configured, for each purchase of goods or services, to assist a buyer and a seller to interact with one another by posting transactions on a distributed ledger, one or more of the transactions include deadlines relating to the purchase;
one or both of: (A) the widget or the web site configured to prompt the buyer to input number-mappable ratings of the seller regarding the purchase and to prompt the seller to input number-mappable ratings of the buyer regarding the purchase, wherein (i) one or more processors and/or (ii) the widget or the web site, are configured to transmit to the distributed ledger for storage thereon the number-mappable ratings, and (B) the one or more processors configured to generate automated numerical ratings of the seller's and the buyer's compliance with deadlines stated in the transactions of the purchase,
an extraction program configured to extract the number-mappable ratings and/or the automated numerical ratings from multiple invoices on the distributed ledger,
the one or more processors configured to:
(A) use the extracted number-mappable ratings in aggregate and/or the automated numerical ratings in aggregate to generate overall current reputation ratings for the buyer and for the seller that are updateable after each purchase and accessible by the widget or the web site; and
(B) upon a particular buyer or particular seller disputing an amount on the distributed ledger, quantitatively compare an overall current reputation rating of the particular buyer and of the particular seller, and generate based on the quantitative comparison an automated resolution of the amount by automatically recording on the distributed ledger an adjustment of a crypto-currency account of one or more of the particular buyer and the particular seller.

In some embodiments, the one or more processors are configured to reward the particular buyer with a higher share of the disputed amount than the particular seller if the particular buyer has a higher overall current reputation rating than the particular seller.

In some embodiments, the one or more processors are configured to use a ratio of (i) the overall current reputation rating of the particular buyer to (ii) the overall current reputation rating of the particular seller to determine an amount of the adjustment.

In some embodiments, the one or more processors are configured to adjust upward a portion of the amount disputed awarded to the seller or to the buyer based on the relative overall current reputation rating between the buyer and the seller.

In some embodiments, the system further comprises both (A) the widget or the web site configured to prompt the buyer to input number-mappable ratings of the seller regarding the purchase and to prompt the seller to input the number-mappable ratings of the buyer regarding the purchase, and (B) the one or more processors and configured to provide the automated numerical ratings of the seller's and the buyer's compliance with deadlines stated in the transactions of the purchase. In some embodiments, the seller and/or the buyer is prompted by the widget or the web site to select whether the extraction program extracts the number-mappable ratings, the automated numerical ratings or both the number-mappable ratings and the automated numerical ratings. In some embodiments, the extraction program is configured to extract both the number-mappable ratings and the automated ratings and wherein the web site or the widget is configured to display a version of the overall current reputation ratings of the buyer and/or seller based on the number-mappable ratings, a version based the automated ratings and a version based on both the number-mappable ratings and the automated ratings, wherein the buyer and/or the seller is prompted to select one of the three versions for purposes of the automated resolution of the amount in dispute.

In some embodiments, the one or more processors are configured to either (i) give less weight to number-mappable ratings by the buyer rating of the seller as to a first purchase compared to the buyer rating of the seller as to a subsequent purchase or (ii) give more weight to number-mappable ratings of the buyer rating the seller as to the first purchase compared to the buyer rating the seller on the subsequent purchase.

In some embodiments, the one or more processors are configured to either (i) assign less weight to number-mappable ratings of the seller rating the buyer as to a first purchase compared to the seller rating the buyer on a subsequent purchase or to (ii) assign more weight to number-mappable ratings of the seller rating the buyer as to the first purchase compared to the seller rating the buyer on the subsequent purchase.

In some embodiments, the automated numerical ratings of the seller are also based on whether and how soon the buyer accepted the goods or services.

In some embodiments, the (i) widget or the web site and/or (ii) the one or more processors are configured to transmit to the distributed ledger for storage thereon, by invoice ID, a purchase price and description of the purchased goods or services and the identity of the buyer and the seller.

In some embodiments, a text of the buyer's rating of the seller is recorded for the purchase on the distributed ledger along with the number-mappable rating.

In some embodiments, the widget or the extraction program is configured to retrieve the text from the distributed ledger and display it on the widget or web site.

In some embodiments, the widget or the web site or the one or more processors are configured to be used by the buyer or seller in order to post, on the distributed ledger, communications by the buyer and by the seller concerning the purchase regarding one or more of payment, acceptance or rejection of the goods or services, curing a defect in the goods or services and declaring a dispute.

In some embodiments, the one or more processors are configured to automatically escrow funds of the buyer on the distributed ledger in an amount of a purchase price pending delivery by the seller.

In some embodiments, if the buyer or the seller declares a dispute of the purchase, the one or more processors are configured to automatically penalize both the buyer and the seller in future calculations of either or both of the automated numerical ratings or the overall current reputation ratings.

In some embodiments, the widget or the web site are configured to facilitate a posting of a transaction on the distributed ledger under the following conditions:
(a) the seller presents the buyer with an invoice including a timeframe for the buyer to approve delivery, and including a negotiation timeframe, wherein the buyer inputting approval on the widget or the web site triggers the one or more processors to record and hold an amount of the purchase price in crypto-currency in escrow on the distributed ledger pending the seller posting that delivery occurred,
(b) the seller declares delivery, wherein failure of delivery being declared results in a reversal of the escrowed purchase price in crypto-currency and the overall current, reputation rating of the seller is automatically reduced for inability to deliver on time,
(c) the seller requests a specific amount of more time to deliver, wherein failure by the buyer to approve results in a resolution equivalent to the seller's failure to deliver,
(d) the buyer finds the delivery to be inadequate during a duration of the negotiation timeframe, which duration defines a deadline to accept delivery,
(e) the buyer does not respond to the delivery within the negotiation timeframe, wherein the one or more processors are configured to mark the invoice as delivered on the distributed ledger and the amount held in escrow is released to the seller.

In some embodiments, the one or more processors are configured to reduce the overall current reputation rating of the buyer if the buyer does not respond to the delivery within the negotiation timeframe.

A further embodiment is a method of using bilateral ratings on distributed ledgers to establish reliable reputations and resolve disputes automatically, comprising:
for each purchase of goods or services, using a widget or a web site to allow a buyer and a seller to interact with one another by posting transactions on a distributed ledger, one or more of the transactions include deadlines relating to the purchase;
for each purchase, either
   (I) (A) using the widget or the web site to provide number-mappable ratings by the buyer of the seller and by the seller of the buyer regarding the purchase, and (B) extracting, by an extraction program the posted transactions evidencing the seller's or the buyer's compliance or noncompliance with a deadline for the purchase, or
   (II) extracting, by the extraction program the posted transactions evidencing the seller's or the buyer's compliance or noncompliance with the deadline for the purchase,
transmitting for storage on the distributed ledger, by (i) one or more processors and/or (ii) the widget or the web site, the number-mappable ratings of the buyer and seller and details of the purchase,
aggregating and using, by the one or more processors, (i) the posted transactions evidencing the seller's and the buyer's compliance or noncompliance with the deadline or (ii) the number-mappable ratings and the posted transactions evidencing the seller's or the buyer's compliance or noncompliance with a deadline, from multiple purchases on the distributed ledger to generate overall current reputation ratings for the buyer and for the seller that are updateable after each purchase and accessible by the widget or the web site; and
upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

In some embodiments, the method further comprises rewarding, by the one or more processors, the particular buyer with a higher share of the disputed amount than the particular seller if the particular buyer has a higher overall current reputation rating than the particular seller.

In some embodiments, the method further comprises using, by the one or more processors, a ratio of (i) the overall current reputation rating of the particular buyer to (ii) the overall current reputation rating of the particular seller, to determine an amount of the adjustment.

In some embodiments, the method further comprises adjusting upward, by the one or more processors, a portion of the amount disputed awarded to the seller or to the buyer based on the relative overall current reputation rating between the buyer and the seller.

In some embodiments, the method further comprises using the one or more processors and/or the extraction program to translate the posted transactions evidencing the seller's and the buyer's compliance or noncompliance with the deadlines into quantitative increases or decreases to be applied by the one or more processors in generating the overall current reputation ratings.

In some embodiments, the method further comprises for each purchase (A) using the widget or the web site to provide the number-mappable ratings by the buyer of the seller and by the seller of the buyer regarding the purchase and (B) extracting the posted transactions describing the instances of the seller's and the instances of the buyer's compliance or noncompliance with deadlines for the purchase and using the one or more processors to assign the quantitative rewards or penalties to all the instances.

In some embodiments, the method further comprises extracting the transactions evidencing the seller's and the buyer's compliance or noncompliance with the deadlines stated in the transactions of the purchase and using the one or more processors to aggregate the extracted transactions from the multiple purchases on the distributed ledger, and to generate the overall current reputation ratings for the buyer and for the seller based on the aggregated and extracted transactions.

A still further embodiment is a system for using bilateral ratings on distributed ledgers to establish reliable reputations and resolve disputes automatically, comprising:
a widget or a web site configured, for each purchase of goods or services, to allow a buyer and a seller to interact with one another by posting transactions on a distributed ledger, one or more of the transactions include deadlines relating to the purchase;
either
   I. an extraction program configured to extract the posted transactions that evidence the seller's or the buyer's compliance or noncompliance with deadlines for the purchase, or
   II. (A) the widget or the web site configured to prompt number-mappable ratings by the buyer of the seller and by the seller of the buyer regarding the purchase, and (B) an extraction program configured to extract the posted transactions evidencing the seller's or the buyer's compliance or noncompliance with deadlines for the purchase, wherein (i) one or more processors and/or (ii) the widget or the web site are configured to transmit to the distributed ledger for storage thereon the number-mappable ratings and details of the purchase,
the one or more processors configured to aggregate and use (i) the extracted posted transactions or quantitative increases and decreases to which such extracted posted transactions have been translated or (ii) the number-mappable ratings and the extracted posted transactions or quantitative increases and decreases to which such extracted posted transactions have been translated, from multiple purchases on the distributed ledger to generate overall current reputation ratings for the buyer and for the seller that are updateable after each purchase and accessible by the widget or the web site; and
upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

In some embodiments, the one or more processors and/or the extraction program is or are configured to translate the posted transactions evidencing the seller's or the buyer's compliance or noncompliance with the deadlines into quantitative increases or decreases to be applied by the one or more processors in generating the overall current reputation ratings.

Another embodiment is a method of ranking a trustworthiness of one or a plurality of wallets, each wallet being a closed digital wallet or a crypto-wallet, comprising:
for each wallet of the one or the plurality of wallets:
for each user who interacts with the wallet:
using a payment widget configured to prompt the user to make payments to the wallet, and to prompt the user of the wallet to, during a transaction that utilizes the wallet, input a review of the wallet, the payment widget part of an application downloadable to a device of the user, receiving, by one or more processors, and storing in a database maintained by the one or more processors, the reviews of the wallet by the user, the wallet identified in the database by a unique public address, setting, by the one or more processors, a value or a range of values of each stored review of the user in a series of transactions using the wallet, and determining, using the one or more processors, a ranking or rating of the trustworthiness of the wallet based on a function applied to the values of each of the stored reviews.

In some embodiments, the wallet is configured for crypto-currency and is associated with a distributed ledger and wherein the one or more processors are configured to transmit the reviews to the distributed ledger to be recorded. In some embodiments, the method further comprises having the wallet issue a transaction receipt for the transaction. In some embodiments, the transaction receipt is generated by the payment widget and transmitted to the distributed ledger to be recorded using the payment widget and/or the one or more processors.

In some embodiments, the wallet is a custodial wallet.

In some embodiments, the payment widget prompts the user to actuate an input that takes the user to a web site where the user has an opportunity to input the review.

In some embodiments, the method further comprises traversing, by the one or more processors, a chain of transactions of a particular user of the users and setting the value or range of values for each review of the wallet by the particular user; and determining, using the one or more processors, a ranking or rating of the trustworthiness of the wallet based on the function applied to at least some of the values of each of the stored reviews by the particular user. In some embodiments, the method further comprises determining, by the one or more processors, an overall ranking or rating of the trustworthiness of the wallet based on the function by traversing all reviewed transactions-of the users-that were recorded in a distributed ledger associated with the wallet.

In some embodiments, the method further comprises transmitting, by the one or more processors, to a device of the user who submits a review, a code or a prompt for use in verifying an authenticity of the review.

In some embodiments, the code is a QR code and each of the QR codes has as an input a selfie of the user, the selfie appearing as part of the review transmitted by the one or more processors to the distributed ledger to be recorded or to the closed digital wallet.

In some embodiments, the code is a QR code transmitted to a mobile device of the user, the QR code containing a web site address managed or operated by the one or more processors.

In some embodiments, the code is a QR code that has an image either embedded within the QR code or is configured to be received along with the QR code for display on a web page.

In some embodiments, the method further comprises transmitting, by the one or more processors, a dynamic QR code to a mobile device of the user.

In some embodiments, the method further comprises determining, using the one or more processors, an updated ranking or rating of the trustworthiness of the wallet based on the function applied to values of each newly stored reviews.

In some embodiments, the review of the wallet pertains specifically to a payment aspect of the wallet. In some embodiments, the review of the wallet evaluates a payment policy and/or a payment procedure of the business or organization that owns the wallet. In some embodiments, the review of the wallet evaluates how reliable the business or organization that owns the wallet is in regard to assuring that funds paid using the wallet result in receipt by the user of the goods or services promised to the user.

Another embodiment is a system for ranking a trustworthiness of one or a plurality of wallets having a public address, comprising: one or more processors configured to execute programming instructions stored on a memory storage unit; a database stored on the memory storage unit and maintained by the one or more processors, for each of the one or the plurality of wallets, an application including a payment widget downloadable to a device of a user who interacts with the wallet, the payment widget configured to prompt the user to make payments to the wallet and configured to prompt users of the wallet to, during a transaction that utilizes the wallet, input a review of the wallet that the device of the user transmits to the database; the one or more processors configured to execute the programming instructions so as to, for each wallet of the one or the plurality of wallets: receive and store in the database the reviews of the wallet by each of the users, the wallet identified in the database by a public address unique to the wallet; set a value or a range of values of each stored review of the users in a series of transactions using the wallet; and determine a ranking or rating of the trustworthiness of the wallet based on a function applied to the values of each of the stored reviews.

In some embodiments, the wallet is configured for payment using crypto-currency and is associated with a distributed ledger and wherein the one or more processors are configured to transmit the reviews to the distributed ledger to be recorded. In some embodiments, the payment widget is configured to generate a transaction receipt on behalf of an owner of the wallet and transmit the transaction receipt to the distributed ledger for recordation of the transaction between the user and the owner of the wallet, the transaction receipt providing details of the transaction In some embodiments, the wallet is a custodial wallet.

In some embodiments, the payment widget prompts the user to actuate an input that takes the user to a web site where the user has an opportunity to input the review.

In some embodiments, the one or more processors are also configured to traverse a chain of transactions of a particular user of the users and set the value or range of values for each review of the wallet by the particular user; and determine a ranking or rating of the trustworthiness of the wallet based on the function applied to at least some of the values of each of the stored reviews by the particular user. In some embodiments, the one or more processors are configured, to determine an overall ranking or rating of the trustworthiness of the wallet based on the function by traversing all reviewed transactions-of a plurality of the particular users-that were recorded in a distributed ledger associated with the wallet.

In some embodiments, the one or more processors are configured to execute the programming instructions so as to, for each wallet of the one or the plurality of wallets: transmit, for each of the users of the wallet, to the device of the user who submits the user's review, a code or a prompt, for verifying an authenticity of the review. In some embodiments, the code is a QR code and each of the QR codes has as an input a selfie of the user, the selfie appearing as part of the review recorded in the distributed ledger. In some embodiments, the code is a QR code transmitted to a mobile device of the user, the QR code containing a web site address managed or operated by the one or more processors. In some embodiments, the code is a QR code that has an image either embedded within the QR code or is configured to be received along with the QR code for display on a web page. In some embodiments, the one or more processors are configured to execute the programming instructions so as to, for each wallet of the one or the plurality of wallets: transmit, for each of the users of the wallet, to a mobile device of the user who submits the user's review, a dynamic code for verifying an authenticity of the review

In some embodiments, the system further comprises determining, using the one or more processors, an updated ranking or rating of the trustworthiness of the wallet based on the function applied to values of each newly stored reviews.

In some embodiments, the review of the wallet pertains specifically to a payment aspect of the wallet. In some embodiments, the review of the wallet evaluates a payment policy and/or a payment procedure of the business or organization that owns the wallet. In some embodiments, the review of the wallet evaluates how reliable the business or organization that owns the wallet is in regard to assuring that funds paid using the wallet result in receipt by the user of the goods or services promised to the user.

### BRIEF DESCRIPTION OF THE DRAWINGS

Various embodiments are herein described, by way of example only, with reference to the accompanying drawings, wherein:

FIG. 1 is a flow chart showing a method, in accordance with one embodiment;

FIG. 2 is a flow chart showing a further method, in accordance with one embodiment;

FIG. 3 is a flow chart showing a still further method, in accordance with one embodiment;

FIG. 4A is a schematic illustration of the details of several purchases on a distributed ledger, in accordance with one embodiment;

FIG. 4B is a schematic illustration of the transactions of a purchase of furniture posted on a distributed ledger, in accordance with one embodiment;

FIG. 4C is a schematic illustration of the transactions of purchase of software posted on the distributed ledger, in accordance with one embodiment;

FIG. 5 is a schematic illustration of a system ion of the details of several purchases on a distributed ledger, in accordance with one embodiment;

FIG. 6 is a schematic diagram of a system, in accordance with one embodiment;

FIG. 7 is a schematic illustration of a payment widget screen that prompts a user to provide a review during a transaction, in accordance with one embodiment;

FIG. 8 illustrates a wallet trustworthiness review pertaining to a payment aspect of the wallet, in accordance with one embodiment;

FIG. 9 illustrates another wallet trustworthiness review pertaining to a payment aspect of the wallet, in accordance with one embodiment;

FIG. 10 illustrates a further wallet trustworthiness review pertaining to a payment aspect of the wallet, in accordance with one embodiment.

FIG. 11 is a flow chart of a method relating to many users, in accordance with one embodiment;

FIG. 12 is a flow chart of a method relating to a particular user, in accordance with one embodiment;

FIG. 13 is a flow chart of a method representing a modified version of FIG. 11, in accordance with one embodiment;

FIG. 14 is a flow chart of a method representing a modified version of FIG. 12, in accordance with one embodiment;

FIG. 15 is a schematic illustration of payment flow using a crypto-wallet and a distributed ledger and facilitated by a system, in accordance with one embodiment and

FIG. 16A illustrates possible first sentences of a wallet trustworthiness review pertaining to a payment aspect of the wallet that is proposed by an AI program, in accordance with one embodiment;

FIG. 16B illustrates possible second sentences of a wallet trustworthiness review pertaining to a payment aspect of the wallet that is proposed by the AI program, in accordance with one embodiment;

FIG. 16C illustrates possible third sentences of a wallet trustworthiness review pertaining to a payment aspect of the wallet that is proposed by an AI program, in accordance with one embodiment; and

FIG. 16D illustrates possible final sentences of a wallet trustworthiness review pertaining to a payment aspect of the wallet that is proposed by an AI program, in accordance with one embodiment..

### DETAILED DESCRIPTION OF THE EMBODIMENTS

The following detailed description is of the best currently contemplated modes of carrying out the invention. The description is not to be taken in a limiting sense, but is made merely for the purpose of illustrating the general principles of the invention, since the scope of the invention is best defined by the appended claims.

As used herein, the term “number-mappable” ratings refers to ratings that are either numerical or are readily capable of being mapped (for example by a processor) to a number. For example, “Excellent, Good, Average, Below Average, Poor” as all-inclusive choices of available ratings of the buyer or seller are readily mappable to 5, 4, 3, 2, 1. In contrast, a descriptive rating or a comment is not number-mappable. For example, the comments “I liked the seller a lot because he was efficient”, “He performed decently” are not clearly mappable to a number. Even “He performed excellently” is not number-mappable because we do not know what the other comments are and how they might map to specific numbers in a repeatable way. If all the comments were one of the following five: “his performance was excellent, his performance was good, his performance was average, his performance was below average, his performance was poor”, then they would be number-mappable.

“Reputation” (of sellers) refers to a reputation for any of the traits that buyers care about in sellers and “reputation” (of buyers) refers to a reputation for any of the traits that sellers care about in buyers. Examples of such traits that buyers care about in sellers and that sellers care about in buyers are trustworthiness and reliability, and this is in the context of a purchase or sale or in the context of an aggregation of such purchases and sales. For example, the seller's reputation is affected by the seller's delivering goods or services within an agreed upon timeframe and by the quality or acceptability of the goods/services delivered or attempted to be delivered.

The word “trustworthiness” as used in the phrases “trustworthiness reputation” or “trustworthiness reputation ratings” as used herein is a catch-all phrase for all of the desirable traits that are evaluated in determining the reputation of the seller or of the buyer.

“Reliable reputations” as used herein refers to reputations that are accurate that is, they accurately mimic the traits that were evaluated to establish such reputations.

The term “purchase” as used herein refers to a purchase by a buyer (which is also simultaneously a sale by a seller) of goods or services, such as one for which a purchase order or invoice may be issued. A transaction or a ledger transaction or a blockchain transaction, in contrast, is a posting by a seller or buyer of a record on the distributed ledger (such as Blockchain) of some step or aspect of the above-defined “purchase”. The term “overall transaction” is occasionally used herein to refer to the purchase (and yet still distinguish it from the terms “transaction” or “ledger transaction” used herein that refer to the event or step posted on the distributed ledger) since in common parlance outside of the world of distributed ledgers the English word “transaction” is often used to refer to an overall business purchase.

In some embodiments, the distributed ledgers are decentralized distributed ledgers.

Applicant believes that in the future, crypto-wallets may be as ubiquitous as website domains and that the crypto-wallet owner's reputation behind such wallets will be valuable.

Certain embodiments generally provide a system and/or a method of using bilateral ratings on distributed ledgers to establish reliable reputations of sellers and buyers who use a crypto-wallet for a purchase recorded on the distributed ledger. The reputation ratings are in some embodiments used to automate dispute resolution between the buyer and the seller concerning a particular purchase. A widget 40 or a web site 45 may be used to assist the buyer and seller in posting transactions on a distributed ledger about the purchase. The invoice ID and/or the seller ledger address and/or the buyer's ledger address may be used for each transaction posted on the distributed ledger 33. Ratings that are either numerical or number-mappable may be inputted by the buyer and by the seller (of each other) and posted to the distributed ledger with the assistance of the widget or the web site. In some embodiments, either alternatively or in addition, automated ratings are generated based on compliance with deadlines. For example, for each purchase, one or more of: (A) using the widget or the web site to provide number-mappable ratings by the buyer of the seller and by the seller of the buyer regarding the purchase that are transmitted to the distributed ledger for storage thereon by one or both of (i) one or more processors and (ii) the widget or the web site, and (B) generating automated numerical ratings by the one or more processors based on the seller's and the buyer's compliance with deadlines stated in the posted transactions. An extraction program may extract the number-mappable ratings and/or the automated numerical ratings from multiple invoices on the distributed ledger, and the one or more processors may use the number-mappable ratings in aggregate and/or the automated numerical ratings in aggregate to generate an overall current reputation ratings for the buyer and for the seller that are accessible by the widget or the web site and updateable after each purchase. Upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

In some embodiments, instead of the automated ratings being prepared for each invoice, an extraction program extracts posted transactions that evidence instances of the seller's and the buyer's compliance or noncompliance with deadlines for the purchase. In some cases, the one or more processors also assign quantitative increases (rewards) or decreases (penalties) relating to the overall reputation rating to the instances. In either case (i.e. whether there is an intermediate step of assigning increases or decreases), these posted transactions are then used to generate the overall current reputation ratings of the buyer and of the seller.

In contrast to current business reviews, the ratings described herein-whether human-inputted ratings, automated ratings or overall reputation ratings-are bilateral. In at least some embodiments, not just the business is reviewed, but the buyer's conduct during the purchase is also reviewed by the seller. Furthermore, in contrast to known ratings, which are typically human-inputted, in at least some embodiments of the systems and methods described herein, the ratings may be both human-inputted ratings and ratings that have been automatically generated by one or more processors. In such a case, moreover, the one or more processors may integrate these different types of rating using an algorithm. The one or more processors may for example apply a mathematical function that integrates them. Moreover, in contrast to the publicly available information about a purchase, in the systems and methods described herein, future prospective purchasers from the seller's business-as well as prospective sellers of the buyer-may review both the overall current reputation rating of the seller or of the buyer (as the case may be) as well as the particular posted ledger transactions stored on the distributed ledger (under a particular invoice ID), which ledger may be immutable, and that make up the purchase (the overall “transaction”) in order to see how the party (the seller or the buyer, whoever is being checked up on) conducted themselves during the purchase. This provides more useful information than is currently available to prospective business partners of the buyer or seller. In addition, in contrast to currently available business reviews, which are based on the experience of the same buyer whether from one or more than one purchases, the overall current reputation ratings of the methods and systems described herein (which may be bilateral (i.e. of the buyer and of the seller)) draw not just on one or many purchases of a particular buyer, but rather integrate together the opinions (i.e. the ratings) of many different buyers (and with respect to ratings of the sellers, they integrate the opinions (i.e. ratings) of many different sellers. Beyond that, they further integrate automated ratings with the human-inputted ratings, at least in some embodiments, to yield the overall current reputation ratings of the buyer or seller.

It is noted that the systems and methods described herein may relate to the trustworthiness reputation of any seller (or buyer) whether the seller is a business or a charitable or other nonprofit or not-for-profit institution (in which case the “buyers” may be donors to the charitable institution who make payments using the crypto-wallet).

In any embodiment herein, the buyer-inputted ratings may concern any aspect of the performance of the seller during the purchase, whether the fairness of the price, the payment process, the quality of the goods or services delivered, the delivery schedule being met or anything else. Similarly, the seller's rating of the buyer may concern any aspect of the conduct of the buyer during the purchase, such as how many questions the buyer asked, whether the buyer paid on time, the overall reliability and efficiency or anything else.

A broad outline of the work flow for certain embodiments comprises:
(a) Create Rating(s)
(b) Extract Rating(s)
(c) Aggregate Ratings to Determine an Overall Rating
(d) Resolve Dispute Between a Buyer and a Seller by Comparing Overall Current Reputation Rating of Buyer with that of the Seller and by Adjusting Accounts of Buyer and/or Seller on Distributed Ledger

The principles and operation of Bilateral Trustworthiness Reputation Ratings for Crypto-Wallets, Automated Dispute Resolution and Trustworthiness Ratings for Digital Wallets and Crypto-Wallets may be better understood with reference to the drawings and the accompanying description.

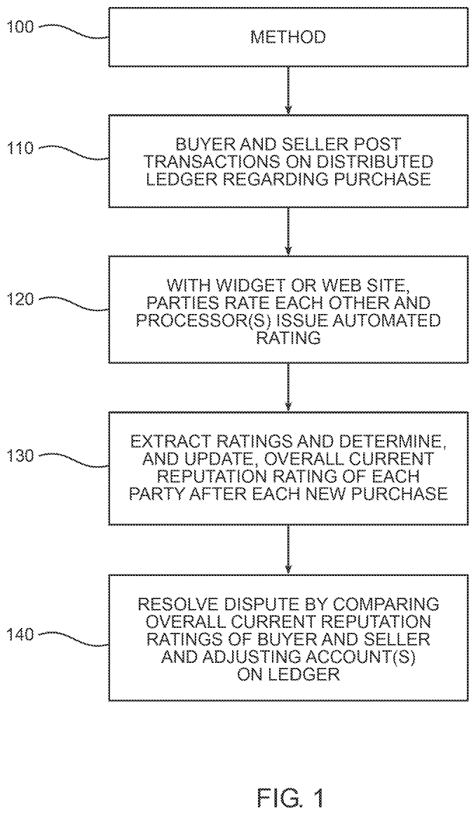

As shown by the flow chart of FIG. 1, one embodiment is a method 100 of using bilateral ratings on distributed ledgers to establish reliable reputations and resolve disputes automatically. In one version, method 100 may include a step of the buyer and seller posting transactions on a distributed ledger 33 (for example Blockchain) regarding a purchase. This may be accomplished using a widget 40 or a web site 45. The widget may be part of an application and may be downloadable onto a user device 99 of a buyer or seller. The posting of the transaction on the ledger 33 by one of the parties-for example the buyer-may trigger an email or other electronic communication being sent to the other party to the purchase-for example the seller (and likewise, if the post was by the seller the email or other communication would be to the buyer). Any such transaction would reference the ledger address of the party to whom it was sent (as well as the party posting the transaction and the invoice ID of the ledger). The posted transactions—or some of them—may reference a deadline for the buyer or seller to comply with. For example, a posted transaction may state a delivery window (for example a duration of time such as 7 days) for the seller to deliver the deliverables. Another example of a deadline in a transaction is negotiation window (for example a duration of time such as 7 days) for the buyer to approve delivery or negotiate with the seller regarding the deliverables. Another example is that after the invoice is recorded onto the blockchain as a “blockchain purchase”, the seller has the duration of the delivery window to deliver the deliverables. Another example is that if the seller fails to post a purchase onto the blockchain declaring that the deliverables have been delivered, the invoice is marked as undelivered (the consequences of that are outlined below but they could include things such as the amount held in escrow is returned to the buyer and/or the seller gets an automatic deduction in future calculations to their reputation due to their inability to deliver the deliverables on time). Another example is that if the seller needs more time to deliver the deliverables, he can post a different transaction onto the blockchain asking for an additional amount of time (specified by the seller when he requests the extension) from the buyer. The buyer then may have a duration equal to half (or some other fraction of) the duration of the delivery window to approve the extension or it will be automatically rejected and the invoice would be resolved the same as if the seller was unable to deliver the deliverables on time. These examples are non-limiting and illustrative.

The posted transactions, which may be facilitated by the widget 40 or by the web site 45 (or in some embodiments by the one or more processors 20) may concern the purchase, for example (this is a non-limiting example), one or more of payment, acceptance or rejection of the goods or services, curing a defect in the goods or services and lodging a dispute.

Method 100 may include a further step 120 wherein for each purchase, one or both of the following occur: (A) using the widget or the web site to provide number-mappable (as defined above) ratings by the buyer of the seller and by the seller of the buyer regarding the purchase that are transmitted for storage to the distributed ledger (for example by one or more processors 20 and/or the widget 40 the or web site 45) and (B) generating automated numerical ratings by the one or more processors 20 based on the seller's and the buyer's compliance (or noncompliance) with the deadlines stated in the posted transactions. In some embodiments, other factors used to calculate the automated ratings may include the extent (and timing) of the buyer's acceptance of the goods or services delivered by the seller or how soon the buyer accepted the goods or services. The automated ratings are, in one embodiment, transmitted to the distributed ledger 33 for storage thereon by (i) one or more processors 20 and/or by (ii) widget 40 or web site 45. In another embodiment, the automated ratings are not stored on the ledger 33.

The portion of method step 120 involving the generating of the automatic ratings may involve having the one or more processors 20 take into consideration, in some implementations, a degree of severity of a buyer's and/or of a seller's noncompliance with a deadline stated in a posted transaction (on the ledger 33), for example by assigning different numerical adjustments to different degrees of severity. In one non-limiting version, during the process of determining the automated rating of a buyer or seller, the one or more processors 20 may assign or apply a numerical value (for example a coefficient such as a fractional multiplier) so as to adjust the automated rating in a direction that rewards compliance with deadlines and penalizes noncompliance with deadlines.

In some embodiments, text of the buyer's rating of the seller and/or the seller's rating of the buyer is recorded for the purchase on the distributed ledger along with the number-mappable rating. In some embodiments, the widget or the extraction program is configured to retrieve the text from the distributed ledger and display it on the widget or web site. In some versions of any of the methods or systems herein, there is an intermediary database that is used to store information retrieved from the distributed ledger, wherein the widget is configured to read the information from the database.

In some embodiments of method 100 (or other methods 200, 300), one or more particular buyers or sellers may fail to provide a rating of the other party to the purchase (i.e. the buyer may fail to provide a rating of the seller or the seller may fail to provide a rating of the buyer) for one or more purchases, for whatever reason.

Method 100 may also comprise a step 130 of extracting, for example by an extraction program, the number-mappable ratings and/or the automated numerical ratings from multiple invoices on the distributed ledger 33. Step 130 may also include using, by the one or more processors 20, the number-mappable ratings in aggregate and/or the automated numerical ratings in aggregate to determine or generate overall current reputation ratings for the buyer and for the seller. The ratings, especially the number-mappable ratings inputted by the buyer and the seller (and in some embodiments also the automated numerical ratings) may be accessible by the widget or the web site. These ratings may be updateable after each purchase.

Another step 140 of method 100 may be that upon a particular buyer or particular seller disputing an amount on the distributed ledger (for example by posting that he has a dispute with the other party (the buyer with the seller or the seller with the buyer) disputes the fact in a transaction on the ledger), quantitatively comparing, by the one or more processors 20, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

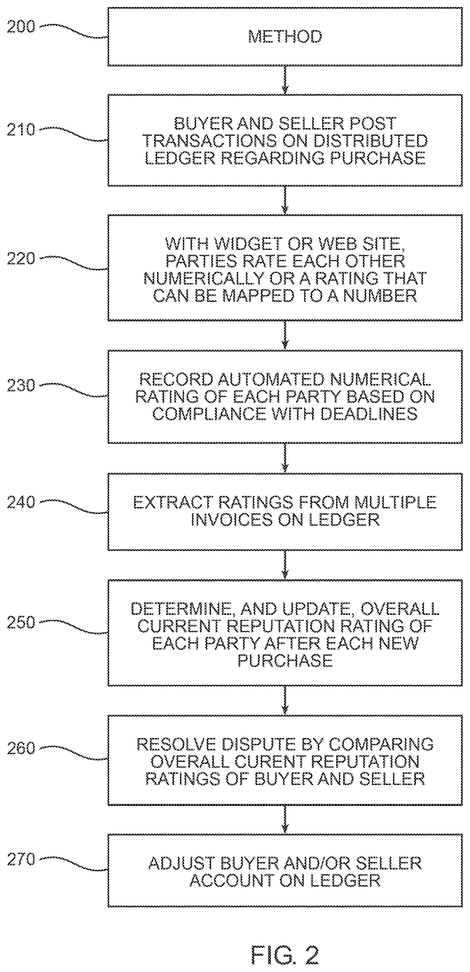

Another method shown by the flow chart of FIG. 2, is method 200. Method 200 is simply a different way of dividing up the steps of method 100. Therefore, any implementation described herein with regard to method 100 is understood to be included in method 200.

There are different ways of implementing this dispute resolution step 140 of method 100 or steps 260, 270 of method 200, each of which would be predetermined by an algorithm forming part of software 23 that is configured to be executed by the one or more processors 20.

In one implementation, method 100 or method 200 may further comprise rewarding, by the one or more processors 20, the particular buyer with a higher share of the disputed amount than the particular seller if the particular buyer has a higher overall current reputation rating than the particular seller. A further implementation is adjusting upward, by the one or more processors, a portion of the amount disputed awarded to the seller or to the buyer based on the relative overall current reputation rating between the buyer and the seller. In some embodiments, methods 100, 200 may further comprise using, by the one or more processors, a ratio of (i) the overall current reputation rating of the particular buyer to (ii) the overall current reputation rating of the particular seller, to determine an amount of the adjustment.

To take one non-limiting example of an automated dispute resolution by the one or more processors 20 interacting with the distributed ledger 33, in accordance with one version of the algorithm in a method of system herein, if the disputed amount is $1,000 and the buyer's overall current reputation rating is 3.5 on a scale of 1 to 5 and the seller's overall current reputation rating is also 3.5, then the disputed amount would (according this version of the algorithm) be divided equally −$500 and $500 and the appropriate adjustment will be made in cryptocurrency to the account of the buyer and of the seller on the ledger 33. However, if the seller's rating is 5 and the buyer's rating is 3, then the seller would (according to this version of the algorithm) instead be awarded ⅝ of the disputed amount, or $625 (and the buyer would be awarded $375). In some embodiments, this allocation is taken from the already escrowed funds. Alternatively, if the algorithm assigns an inherent bias in favor of the buyer for example in order to favor commerce (or because “the client is always right”), or for any other reason, then the buyer's rating could be (according to one version) automatically increased from 3 to 3.5 and the ratio is 3.5/8 or 7/16 or $437.50 to the seller and $62.50 the buyer and their respective cryptocurrency accounts are adjusted accordingly.

In some cases, the methods further comprise having the one or more processors configured to reduce the overall current reputation rating of the buyer if the buyer does not respond to the delivery within the negotiation timeframe. One reason for this is that failure to respond to the delivery within the timeframe delays the release of the purchase price to the seller.

In some embodiments, the one or more processors 20 is configured to favor the buyer for example by providing or assigning a fixed part of the disputed amount to the particular buyer in the automated resolution of the dispute. In one version, the fixed amount is some amount representing less than one-fifth of the disputed amount.

The one or more processors 20 may be configured to execute software 23 so as to give less weight (or more weight or either less weight or more weight) to number-mappable ratings of a buyer rating a seller (or of a seller rating a buyer) as to a first purchase compared to the buyer rating the seller on a subsequent purchase. For example, if the same buyer is rating the same seller over and over, that rating may be less weighty than if a new buyer rates that seller.

The transactions of the purchase may be identified on the distributed ledger by an invoice ID unique to the purchase and may include details of the purchase, for example the purchase price and the identity of the buyer and seller and the item purchased.

Regarding the buyer-inputted ratings and the seller-inputted ratings that are numerical or are mappable to a number, they concern the party's (the party being rated) performance during the transaction. The buyer for example might rate the seller's reliability in delivering the goods or services promised. The seller may for example rate the buyer based on how much time did the buyer use up of the seller during this one purchase. These are just examples and many more are possible.

In some embodiments, the one or more processors 20 are configured to automatically escrow funds of the buyer in an amount of a price of the purchase on the distributed ledger pending delivery by the seller.

In some embodiments, when and if the buyer or the seller lodge a dispute concerning a particular purchase, the one or more processors 20 may be configured to automatically penalize both the buyer and the seller in future calculations of one or both of automated numerical ratings and the overall current reputation ratings.

In some embodiments, the transactions posted on the ledger 33 are posted upon the occurrence of at least the following events:
(a) the seller presents the buyer with an invoice including a timeframe for the buyer to approve delivery, and including a negotiation timeframe, wherein the buyer inputting approval on the widget or the web site triggers the one or more processors to record and hold an amount of the purchase price in crypto-currency in escrow on the distributed ledger pending the seller posting that delivery occurred,
(b) the seller declares delivery, failure of which results in reversal of the amount of the escrowed crypto-currency funds and the overall current reputation rating of the seller automatically reduced for inability to deliver on time,

In some embodiments, if the seller fails to post a purchase onto the distributed ledger declaring that the deliverables have been delivered, the invoice is marked on the ledger as undelivered and the amount held in escrow is returned to the buyer. The seller gets an automatic deduction in future calculations to their reputation due to their inability to deliver the deliverables on time,
(c) the seller requests a specific amount of more time to deliver, failure of which by the buyer to approve results in a resolution similar to the seller's failure to deliver.
(d) the buyer has a duration of the negotiation timeframe to accept delivery or if the buyer finds the deliverables to be inadequate, and
(e) if the buyer does not respond to the delivery within the negotiation timeframe, the one or more processors mark the invoice as delivered on the distributed ledger (which is slightly different from being approved) and the amount held in escrow is released to the seller.

Method 100 may involve prompting the seller and/or the buyer to select whether the extraction program extracts the number-mappable ratings, the automated numerical ratings or both the number-mappable ratings and the automated numerical ratings. Method 100 may comprise extracting both the number-mappable ratings and the automated ratings and using the web site or the widget to display a version of the overall current reputation ratings of the buyer and/or seller based on the number-mappable ratings, a version based the automated ratings and a version based on both, so that the buyer and/or the seller is prompted to select one of the three versions for purposes of the automated resolution of a dispute.

The buyer and/or the seller's selection may occur at the outset of the invoice in the event that a dispute arises between them.

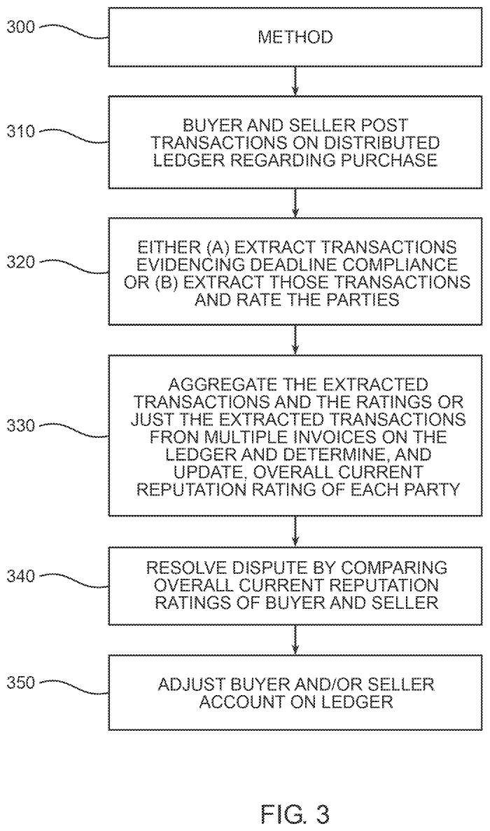

Another embodiment described in the flow chart of FIG. 3 is a method 300 of using bilateral ratings on distributed ledgers to establish reliable reputations and resolve disputes automatically. A step 310 of method 300 may include, for each purchase of goods or services, using a widget 40 or a web site 45 to allow a buyer and a seller to interact with one another by posting transactions on a distributed ledger, one or more of the transactions include deadlines relating to the purchase.

Method 300 differs from methods 100 and 200 mainly in that in method 300, instead of generating automated ratings for each purchase (i.e. for each invoice), the raw inputs that in other methods 100, 200 are used to generate these automated ratings—namely the transactions that evidence compliance or noncompliance with deadlines (or other factors) during each purchase—is not used to create a rating for the purchase itself but rather are left on the distributed ledger 33 to accumulate. Instead, they may in some cases, be used by the one or more processors 20 to aggregate them and then generate the overall current reputation rating. Alternatively, there may be an intermediate step in which the one or more processors are configured to convert the transactions evidencing deadline compliance or noncompliance into quantitative rewards and penalties (i.e. rewards for compliance and penalties for noncompliance). Each reward may comprise a quantitative amount of an increase that is to be applied during the calculation of the overall current reputation ratings by the one or more processors whereas each penalty may comprise a quantitative amount of a reduction that is to be applied to generate these overall current reputation ratings.

The transactions that evidence compliance/noncompliance may include transactions that declare the deadline (such as the deadline for delivery of the goods/services or the buyer's deadline for approving the goods/services delivered) as well as transactions that evidence that the deadline was complied with or was not complied with (i.e. the seller posted a transaction that the goods or services were delivered on such and such date and such delivery on that date is after the deadline or is within the deadline for delivery).

Then during the extraction step this data is extracted (or the quantitative rewards and penalties are extracted) and then (in either case) this is aggregated by the one or more processors 20 and then some mathematical function may be applied so as to generate the overall current reputation ratings of the seller and of the buyer.

Accordingly, in method step 320, for each purchase, either
(I) (A) using the widget or the web site to provide number-mappable ratings by the buyer of the seller and by the seller of the buyer regarding the purchase, the number-mappable ratings transmitted to the distributed ledger for storage thereon (for example by (i) one or more processors 20 and/or (ii) widget 40 or web site 45) and (B) extracting, by an extraction program, the posted transactions evidencing the seller's and the buyer's compliance or noncompliance with deadlines for the purchase, or
(II) extracting, by an extraction program the posted transactions evidencing the seller's and the buyer's compliance or noncompliance with deadlines for the purchase.

Method step 320 may in some versions also include transmitting to distributed ledger 33 for storage thereon any number-mappable ratings of the buyer and seller and details of the purchase. The storing of the ratings on the distributed ledger can be generated by a post of a separate transaction or it can be included with a post of a final transaction of the purchase. Other variations are also plausible.

Method step 330 may include aggregating and using, by the one or more processors, (i) the posted transactions evidencing the seller's or the buyer's compliance or noncompliance with the deadline or the extracted posted transactions or quantitative increases and decreases to which such extracted posted transactions have been translated or (ii) the number-mappable ratings and the posted transactions evidencing the seller's and the buyer's compliance or noncompliance with a deadline, from multiple purchases on the distributed ledger to generate overall current reputation ratings for the buyer and for the seller that are updateable after each purchase and accessible by the widget or the web site.

Method step 330 may involve having the one or more processors 20 take into consideration, in some implementations, a degree of severity of a buyer's and/or of a seller's noncompliance with a deadline stated in a posted transaction (on the ledger 33), for example by assigning different numerical adjustments to different degrees of severity. In one non-limiting version, during the process of determining the overall current reputation rating of a buyer or seller, the one or more processors 20 may assign or apply a numerical value (for example a coefficient such as a fractional multiplier) so as to adjust the overall current reputation rating in a direction that rewards compliance with deadlines and penalizes noncompliance with deadlines.

In method step 340, upon a particular buyer or particular seller disputing an amount on the distributed ledger, step 340 may comprise quantitatively comparing, by the one or more processors, an overall current reputation rating of the particular buyer and of the particular seller. Method step 350 may comprise generating, based on the quantitative comparison, an automated resolution of the amount by automatically recording on the distributed ledger an adjustment of a crypto-currency account of one or more of the particular buyer and the particular seller.

In a version of method 300, the method may further comprise rewarding, by the one or more processors, the particular buyer with a higher share of the disputed amount than the particular seller if the particular buyer has a higher overall current reputation rating than the particular seller.

Regarding the use of the overall current reputation ratings for dispute resolution, method 300 may be implemented by having by the one or more processors use a ratio of (i) the overall current reputation rating of the particular buyer to (ii) the overall current reputation rating of the particular seller, to determine an amount of the adjustment.

Method 300 may also be implemented by adjusting upward, by the one or more processors, a portion of the amount disputed awarded to the seller or to the buyer based on the relative overall current reputation rating between the buyer and the seller.

Method 300 may further comprise using the one or more processors and/or the extraction program (in step 320 or in step 330) to translate the posted transactions evidencing the seller's and the buyer's compliance or noncompliance with the deadlines into quantitative increases or decreases to be applied by the one or more processors 20 in generating the overall current reputation ratings.

Method 300 may also be implemented by extracting the posted transactions for the purchase that evidence the seller's compliance or noncompliance with the deadlines and those that evidence the buyer's compliance or noncompliance with the deadlines of the purchase (such as transaction describing the delivery deadlines or windows or deadlines for the buyer to approve what was delivered or transactions that show the deadline was complied with or was not complied with) and using the one or more processors to aggregate the extracted transactions from the multiple purchases on the distributed ledger, and using the one or more processors to generate the overall current reputation ratings for the buyer and for the seller based on the aggregated extracted posted transactions.

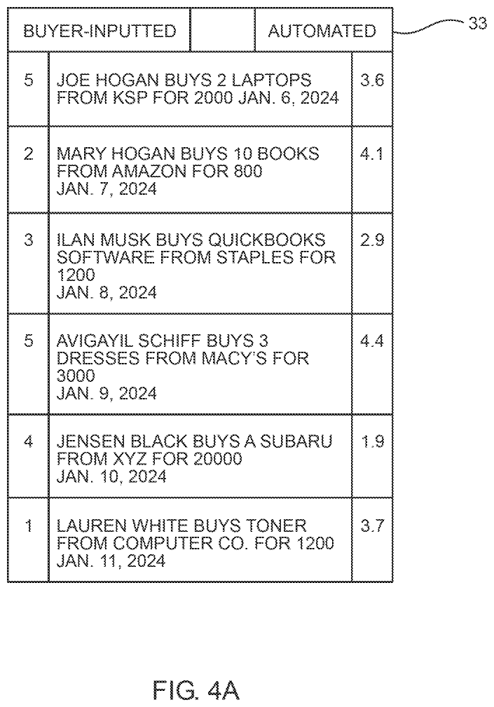

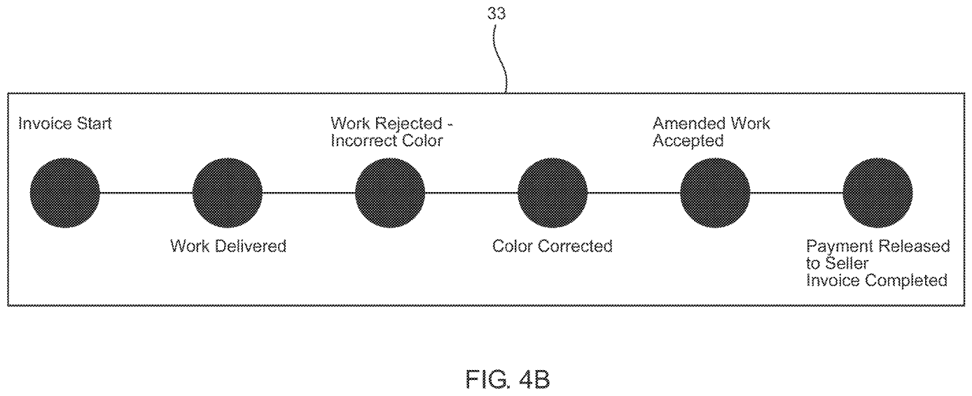

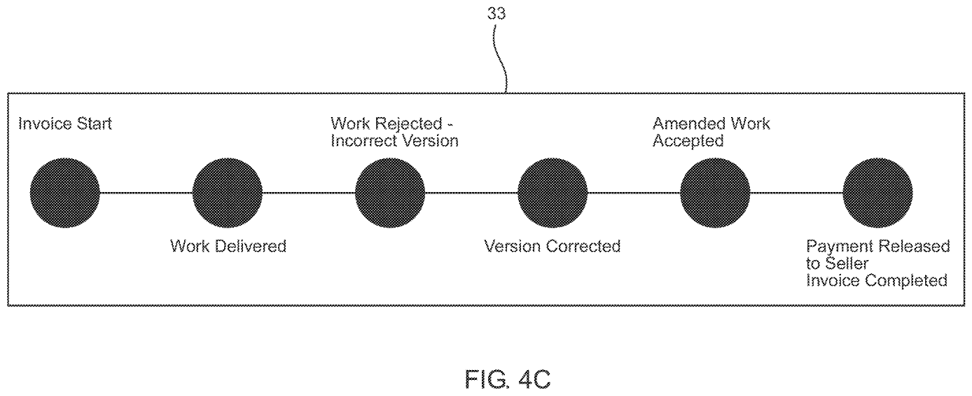

FIG. 4A depicts a distributed ledger 33 with automated ratings on the right side which are not whole integers and buyer-inputted or seller-inputted ratings on the left side, which are whole integers. This is just one non-limiting implementation of the automated and buyer inputted and seller-inputted ratings that are posted on the ledger 33. In this particular version, human buyers and sellers (or a seller-company that is operated by humans) would be prompted to choose from whole integers in the course of rating a buyer's or a seller's performance during a purchase, whereas an algorithm (when it is generating automated ratings of buyers and sellers for a particular transaction) can apply various factors and may be expected to calculate a result that is not necessarily a whole integer.

For methods 100, 200 (and system 10 described hereinafter), one non-limited example of an algorithm that the one or more processors 20 could use to determine the overall current reputation rating of a seller (and similarly a buyer) consistent with FIG. 4A would be to calculate a first average of the automated ratings over a certain number of purchases and a second average of the buyer-inputted ratings from those same purchases and apply a predetermined weight to the first and second averages. The predetermined weight of the first average can be identical to or different from the predetermined weight of the second average. If different, that would be based on assigning a lesser or greater relevance to the automated ratings compared to the buyer-inputted ratings. A similar scenario is applicable to seller-inputted ratings.

FIG. 4B schematically illustrates the transactions of a purchase of furniture of a particular color posted on a distributed ledger 33. The nodes in FIG. 4B represents the transactions of the purchase presented chronologically to form a work flow. “Work delivered” is a transaction that the seller would post. “Work rejected-incorrect color” is a transaction that the buyer posts on the distributed ledger 33. “Color corrected” is posted by the seller. Although the nodes in FIG. 4B are visually juxtaposed, in actuality, the transactions on the distributed ledger.

FIG. 4C schematically illustrates the transactions of a purchase of a particular version of a software product posted on distributed ledger 33. The nodes in FIG. 4C represents the transactions of the purchase presented chronologically to form the work flow. “Work delivered” is a transaction that the seller would post. “Work rejected-incorrect version” is a transaction that the buyer posts on the distributed ledger 33. “version corrected” is posted by the seller.

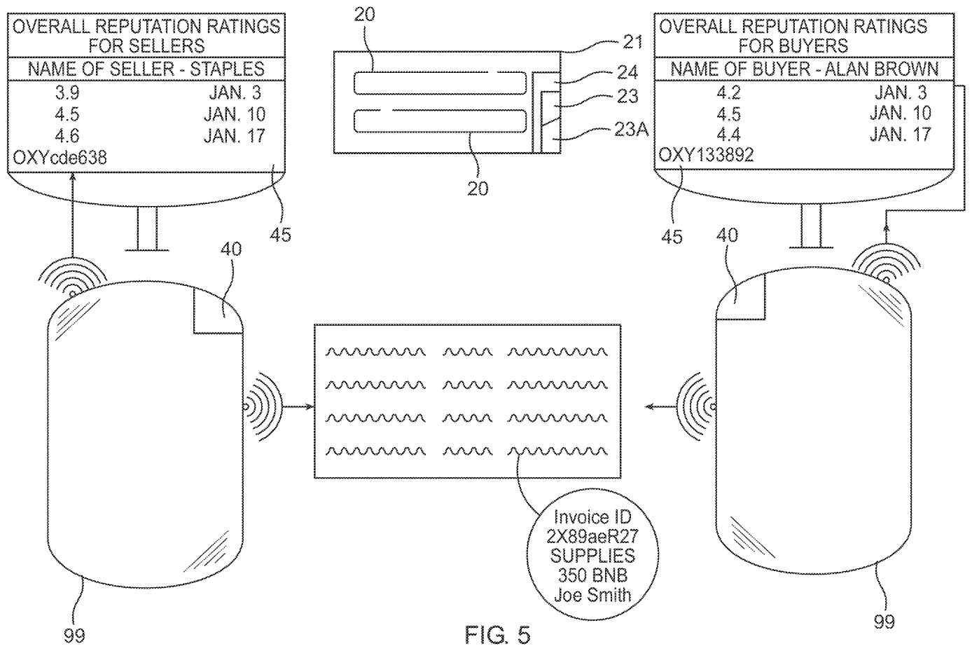

As shown in FIG. 5, a system 10 of using bilateral ratings of buyers and sellers on distributed ledgers to establish reputations and resolve disputes automatically, may include a widget 40 (which may be downloadable alone or as part of an application for example onto a user device 99 of the buyer or the seller) or a web site 45 configured, for each purchase of goods or services, to assist a buyer and a seller to interact with one another by posting transactions on a distributed ledger, one or more of the transactions include deadlines relating to the purchase.

System 10 may also include one or both of:
(A) the widget 40 or the web site 45 is configured to prompt the buyer to input number-mappable ratings of the seller regarding the purchase and to prompt the seller to input number-mappable ratings of the buyer regarding the purchase, wherein at least the number-mappable ratings are transmitted to the distributed ledger 33 for storage thereon (for example by (i) one or more processors 20 and/or by (ii) widget 40 or web site 45), and
(B) one or more processors 20 configured to generate automated numerical ratings of the seller's and the buyer's compliance (or noncompliance) with deadlines stated in the transactions of the purchase. The automated ratings may also take into other factors (besides compliance with deadlines) such as the buyer's acceptance of the goods or services.

The generating of the automatic ratings by the one or more processors 20 of system 10 may involve having the one or more processors 20 take into consideration, in some implementations, a degree of severity of a buyer's and/or of a seller's noncompliance with a deadline stated in a posted transaction (on the ledger 33). In one non-limiting version, during the process of determining the automated rating of a buyer or seller, the one or more processors 20 may apply or assign a numerical value (for example a coefficient such as a fractional multiplier) so as to adjust the overall current reputation rating in a direction that rewards compliance with deadlines and penalizes noncompliance with deadlines.

System 10 include—as part of the software 23 stored on computer readable medium such as memory 24 and executed by its one or more processors 20 of processing unit 21—an extraction program 23A configured to extract the number-mappable ratings and/or the automated numerical ratings from multiple invoices on the distributed ledger and aggregate them together for the one or more processors 20.

In system 10, the one or more processors 20 may be configured to: use the extracted number-mappable ratings in aggregate and/or the automated numerical ratings in aggregate to generate overall current reputation ratings for the buyer and for the seller that are updateable for example after each purchase and that may be accessible by the widget 40 or the web site 45.

The one or more processors 20 may also be configured to: upon a particular buyer or particular seller disputing an amount on the distributed ledger, quantitatively compare an overall current reputation rating of the particular buyer and of the particular seller, and generate based on the quantitative comparison an automated resolution of the amount by automatically recording on the distributed ledger an adjustment of a crypto-currency account of one or more of the particular buyer and the particular seller.

The one or more processors 20 may be configured to reward the particular buyer with a higher share of the disputed amount than the particular seller if the particular buyer has a higher overall current reputation rating than the particular seller. The processor(s) 20 may also be configured to use a ratio of (i) the overall current reputation rating of the particular buyer to (ii) the overall current reputation rating of the particular seller to determine an amount of the adjustment. The one or more processors 20 may be configured to adjust upward a portion of the amount disputed awarded to the seller or to the buyer based on the relative overall current reputation rating between the buyer and the seller.

The buyer, using the buyer widget or a buyer web site, and the seller, using the seller widget or a seller web site, may interact with one another concerning the purchase by posting about the purchase on the distributed ledger, which may automatically trigger an electronic communication to the other party.

The one or more processors 20 may be configured to assign a fixed amount of the disputed amount to the particular buyer in the automated resolution of the dispute, the fixed amount being some amount representing less than one-fifth of the disputed amount.

In some embodiments of systems 10 (as well as of system 400 and of methods 100, 200, 300), the one or more processors 20 may be configured to give more weight to number-mappable ratings by the buyer of the seller as to a first purchase compared to the buyer rating of the seller as to a subsequent purchase. The logic is that repeat opinions might not be based completely on the new purchase but may be based on a memory of earlier purchases. In other embodiments, the one or more processors 20 are configured to give less weight to number-mappable ratings by the buyer of the seller as to a first purchase compared to the buyer rating of the seller as to a subsequent purchase. The converse logic is that the repeat opinions are opinions of a party that may be more well-informed. In still other embodiments, the one or more processors 20 is configured to either give more weight or to give less weight to number-mappable ratings by the buyer rating of the seller as to a first purchase compared to the buyer rating of the seller as to a subsequent purchase. Likewise, the one or more processors 20 may be configured to give more weight (or less weight or either more or less weight) to number-mappable ratings by the seller of the buyer as to a first purchase compared to the seller rating of the buyer as to a subsequent purchase.

In some embodiments of system 10 (or other systems 400), one or more particular buyers or sellers may fail to provide a rating of the other party to the purchase (i.e. the buyer may fail to provide a rating of the seller or the seller may fail to provide a rating of the buyer) for one or more purchases, for whatever reason (or no reason).

The automated numerical ratings of the seller are also based on whether and how soon the buyer accepted the goods or services.

The (i) widget 40 or the web site 45 and/or (ii) the one or more processors 20 may be configured to transmit to the distributed ledger 33 for storage thereon, by invoice ID, a purchase price and description of the purchased goods or services and the identity of the buyer and the seller.

A text of the buyer's rating of the seller may be recorded for the purchase on the distributed ledger along with the number-mappable rating. The widget or the extraction program may be configured to retrieve the text from the distributed ledger and display it on the widget or web site.

Any of the details of methods 100, 200 may be incorporated into system 100 or system 400. Any of the details of method 300 may be incorporated into system 400. For example, any details concerning the nature of any of the ratings or the manner or steps taken by one or more processors 20 to determine the overall current reputation ratings or the manner in which the ratings or deadline compliance transactions or automated ratings are extracted by the extraction program described herein in any of the methods may be utilized in any suitable system. For example:

In some embodiments of system 10, an intermediary database is used to store information retrieved from the distributed ledger 33, wherein the widget 40 is configured to read the information from the database.

In some embodiments of system 10, the widget or the web site or the one or more processors are configured to be used by the buyer or seller in order to post, on the distributed ledger, communications by the buyer and by the seller concerning the purchase regarding one or more of payment, acceptance or rejection of the goods or services, curing a defect in the goods or services and declaring a dispute.

In some embodiments, the one or more processors are configured to automatically escrow funds of the buyer on the distributed ledger in an amount of a purchase price pending delivery by the seller.

In some embodiments, if the buyer or the seller declares a dispute of the purchase, the one or more processors are configured to automatically penalize both the buyer and the seller in future calculations of either or both of the automated numerical ratings or the overall current reputation ratings.

In some embodiments of system 10, both (A) the widget or the web site is configured to prompt the buyer to input number-mappable ratings of the seller regarding the purchase and to prompt the seller to input the number-mappable ratings of the buyer regarding the purchase, and (B) the one or more processors are configured to provide the automated numerical ratings of the seller's and the buyer's compliance with deadlines, and the seller and/or the buyer is prompted by the widget or the web site to select (for example at the outset, in the event that a dispute arises) whether the extraction program extracts the number-mappable ratings, the automated numerical ratings or both the number-mappable ratings and the automated numerical ratings. In another version, the extraction program is configured to extract both the number-mappable ratings and the automated ratings and the web site or the widget is configured to display a version of the overall current reputation ratings of the buyer and/or seller based on the number-mappable ratings, a version based the automated ratings and a version based on both, so that the buyer and/or the seller is prompted to select one of the three versions for purposes of the automated resolution of a dispute.

Another embodiment is a system 400 (see FIG. 5) for using bilateral ratings on distributed ledgers to establish reliable reputations and resolve disputes automatically may comprise a widget 40 or a web site 45 configured, for each purchase of goods or services, to allow a buyer and a seller to interact with one another by posting transactions on a distributed ledger 33, one or more of the transactions include deadlines relating to the purchase.

System 400 further comprises either
I. an extraction program 23A (executable by one or more processors 20) configured to extract from the ledger those posted transactions that evidence the seller's or the buyer's compliance or noncompliance with deadlines for the purchase, or
II. (A) the widget 40 or the web site 45 configured to prompt number-mappable ratings by the buyer of the seller and by the seller of the buyer regarding the purchase, wherein the number-mappable ratings may be transmitted for storage to the distributed ledger (for example by (i) one or more processors 20 and/or (ii) the widget 40 or the web site 45) and (B) an extraction program 23A configured to extract from the distributed ledger 33 those posted transactions that evidence the seller's or the buyer's compliance or noncompliance with deadlines for the purchase, wherein details of the purchases may be transmitted to ledger 33 for storage thereon, by the (i) one or more processors 20 and/or by (ii) widget 40 or web site 45 (such as the item purchased, the names of the buyer and the seller and the purchase price),
wherein the one or more processors 20 are also configured to aggregate and use (i) the extracted posted transactions evidencing buyer or seller deadline compliance or noncompliance or (ii) the number-mappable ratings and the quantitative rewards or penalties, from multiple purchases on the distributed ledger to generate overall current reputation ratings for the buyer and for the seller that are updateable after each purchase and accessible by the widget or the web site.

The one or more processors 20 are also configured, upon a particular buyer or particular seller disputing an amount on the distributed ledger, to quantitatively compare an overall current reputation rating of the particular buyer and of the particular seller, and generate, based on the quantitative comparison, an automated resolution of the amount by automatically recording on the distributed ledger an adjustment of a crypto-currency account of one or more of the particular buyer and the particular seller.

In some embodiments of system 400, the one or more processors 20 and/or the extraction program 23A is or are configured to translate the posted transactions evidencing the seller's or the buyer's compliance or noncompliance with the deadlines into quantitative increases or decreases to be applied in generating the overall current reputation ratings. In one non-limiting version, the one or more processors 20 may assign or apply a numerical value (for example a coefficient such as a fractional multiplier) so as to adjust the overall current reputation rating in a direction that rewards compliance with deadlines and penalizes noncompliance with deadlines.

In some implementations, the one or more processors 20 may also take into consideration a degree of severity of a buyer's and/or of a seller's noncompliance with a deadline stated in a posted transaction (on the ledger 33) by assigning different numerical adjustments to different degrees of severity. Accordingly, another embodiment of system 400 is a system for using bilateral ratings on distributed ledgers to establish reliable reputations and resolve disputes automatically, comprising:
a widget or a web site configured, for each purchase of goods or services, to allow a buyer and a seller to interact with one another by posting transactions on a distributed ledger, one or more of the transactions include deadlines relating to the purchase;
either
   I. an extraction program configured to extract the posted transactions that evidence the seller's or the buyer's compliance or noncompliance with deadlines for the purchase, or
   II. (A) the widget or the web site configured to prompt number-mappable ratings by the buyer of the seller and by the seller of the buyer regarding the purchase, and (B) an extraction program configured to extract the posted transactions evidencing the seller's or the buyer's compliance or noncompliance with deadlines for the purchase, wherein the number-mappable ratings and the details of the purchases may be transmitted to the distributed ledger 33 for storage thereon, for example by (i)
the one or more processors 20 and/or by (ii) widget 40 or web site 45, the one or more processors 20 configured to aggregate and use (i) the extracted posted transactions or quantitative increases and decreases to which such extracted posted transactions have been translated or (ii) the number-mappable ratings and the extracted posted transactions or quantitative increases and decreases to which such extracted posted transactions have been translated, from multiple purchases on the distributed ledger to generate overall current reputation ratings for the buyer and for the seller that are updateable after each purchase and accessible by the widget or the web site; and
upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

The variations of the algorithm for implementing the adjustment of the account of the buyer and/or seller based on the quantitative comparison include any of those described herein with respect to system 10 and methods 100, 200, 300.

The following is one non-limiting example implementing a system 10 or a system 400 or a method 100, 200, 300 of using bilateral ratings-of the seller's crypto-wallet by the buyers and by the sellers (owners of crypto-wallets used by a particular buyer) of the particular buyer-for automated dispute resolution (where blockchain is the example of the distributed ledger 33 that is used) of a dispute between a particular buyer and a particular crypto-wallet owned by the particular seller:

In STEP 1, the seller presents the buyer with an invoice (or purchase order) for a purchase which would be represented by a purchase on the distributed ledger (blockchain being one example of the distributed ledger). The invoice would be presented to the buyer using a payment widget 30 or website that interacts with the distributed ledger. This ledger transaction refers to a posting on blockchain of an step or element of the overall purchase between the buyer and seller) would record the wallet address (i.e. crypto-wallet address) of the seller, buyer, list of deliverables, purchase price to be paid to the buyer, delivery window (a duration of time such as 7 days) for the seller to deliver the deliverables, and negotiation window (a duration of time such as 7 days) for the buyer to approve delivery or negotiate with the seller regarding the deliverables. If the buyer approves the invoice (by clicking approve on the payment widget 30), the blockchain takes the purchase price into escrow, where it is locked in the blockchain purchase and effectively held by the blockchain until the entire process is completed.

In a STEP 2, after the invoice is recorded onto the blockchain as a “blockchain purchase”, the seller has the duration of the delivery window to deliver the deliverables.

In a SUBSTEP 2a, once the deliverables are delivered (which could be nearly instantaneous or take several days), the seller posts another “blockchain purchase” onto the blockchain declaring that the deliverables have been delivered. The seller could post this blockchain purchase using a different widget or website that interacts with the blockchain. This widget or website that interacts with the blockchain would also send notice (e.g. via email) to the buyer that the goods have been delivered.

In a further SUBSTEP 2b, if the seller fails to post a purchase onto the blockchain declaring that the deliverables have been delivered, the invoice is marked as undelivered and the amount held in escrow is returned to the buyer. The seller gets an automatic deduction in future calculations to their reputation due to their inability to deliver the deliverables on time.

In some embodiments, the seller and/or buyer are prompted by the payment widget 30 to leave a review for the other party (the seller is prompted to leave a review of the buyer and the buyer is prompted to leave a review of the seller) in addition to the automatic deduction of reputation for the seller.

In a further SUBSTEP 2c, if the seller needs more time to deliver the deliverables, he can post a different transaction onto the blockchain asking for an additional amount of time (specified by the seller when he requests the extension) from the buyer. The buyer has a duration equal to half the duration of the delivery window to approve the extension or it will be automatically rejected and the invoice would be resolved the same as if the seller was unable to deliver the deliverables on time as in step 2b.

In a further SUBSTEP 2d, if the seller decides he cannot deliver the deliverables for whatever reason, he can post a different transaction onto the blockchain to cancel the invoice. The invoice is then marked as cancelled, the amount held in escrow is returned to the buyer and both parties would be prompted to leave a review rating their experience of interacting with the other party.

In STEP 3, the buyer has the duration of the negotiation window to accept delivery or to negotiate with the seller regarding the delivery, if the buyer finds the deliverables to be inadequate, missing, or unacceptable in some way.

In a SUBSTEP 3a: If the buyer accepts delivery, he posts a purchase onto the blockchain approving the delivery. The invoice is then marked as approved and the funds held in escrow by the blockchain would be immediately released to the seller and both parties would then be notified (again by the widget or website) and be given the opportunity to leave a review for their experience interacting with the other party. If they choose to leave a review, the review would be posted on the blockchain and be taken into account in future calculations of the reputation of that party.

In a further SUBSTEP 3b: If the buyer cannot accept delivery immediately, he posts a different purchase onto the blockchain saying that the delivery is inadequate and either posting a negotiation message to the seller detailing how the delivery can be fixed for approval, or outright rejecting the delivery.

In a further SUBSTEP 3c: If the buyer does not respond to the delivery within the negotiation window, the invoice is marked as delivered (slightly different from approved) and the amount held in escrow is released to the seller. The buyer may receive a slight penalty to future calculations of their reputation for failing to respond to the delivery within the negotiation window (and thus also delaying the release of the purchase price to the seller) and both parties are prompted to leave a review rating their experience interacting with the other party. This penalty may be because this may also delay the release of the purchase price to the seller.

In STEP 4, if the buyer decides to negotiate with the seller regarding the delivery, the seller then has the duration of the negotiation window to post a subsequent purchase in response to the buyer's negotiation message. Both parties would be notified by the widget 30 or website that interacts with the blockchain that the other party has posted a message. The buyer then gets the opportunity to approve the amended delivery or respond again as in STEP 3. This negotiation process can continue indefinitely as long as both parties respond to the other party's last message (represented by a blockchain purchase) within the duration of the negotiation window.

During this negotiation process, either party can propose amendments to the invoice such as changes to the purchase price or deliverables, and if approved by the other party, the original invoice would then be amended by an invoice amendment. After any amendment to the invoice, it will be up to the seller to post a new message saying that the deliverables have been delivered.

The seller can choose to cancel the invoice at any time during the negotiation process and the process would be resolved the same as in SUBSTEP 2d.

If one party fails to respond within the duration of the negotiation window or chooses to end the negotiation (which means the buyer is outright rejecting the delivery or the seller is declaring that the deliverable is acceptable and will not be amended further), the invoice is marked as disputed and the blockchain will automatically resolve the dispute according to the relative reputations of the two parties. The blockchain will disburse a certain portion of the purchase price to the seller based upon the relative reputations of the two parties and return the other portion to the buyer, and the process will be considered complete. Both parties will be prompted to leave a review (which may be in the form of a number-mappable rating) of their interaction with the other party. In this case where the invoice becomes disputed, both parties will be automatically penalized in future calculations of their reputation. In this manner, both parties will be incentivized to work out their differences and resolve the purchase in a manner acceptable to both parties rather than invoke automatic resolution by the blockchain.

If the buyer ultimately accepts delivery after the negotiation, the process ends the same as in STEP 3a.

Any of the details of the above steps of the above example may be incorporated into any method or system described herein including methods 100, 200, 300 and systems 10, 400.

In any embodiment, the function used by the one or more processors 20 for determining the overall current reputation rating of a buyer or of a seller (from the number-mappable ratings in aggregate and/or the automated numerical ratings in aggregate and in other embodiments from the posted transactions evidencing the seller's or the buyer's compliance or noncompliance with a deadline) may be a mathematical function that is a weighted mathematical function. For example, the function may take into account the frequency that a particular level of rating occurs for the wallet.

All of the details, versions, methods and embodiments of the payment code described with respect to system 10, 400 apply equally to the wallet utilized in the methods 100, 200, 300 described herein.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable (storage) medium(s) (for example memory 24) having computer readable program code 23 or programming instructions 23 embodied thereon. The storage medium may be a non-transitory computer readable storage medium.

Any embodiments of system 10, 400 or methods 100, 200, 300 may include any hardware, such as a processing unit 21 or such as one or more processors 20 necessary to execute any of the programming instructions 23 used in such system or method.

Further embodiments will now be described relating to trustworthiness ratings for digital wallets and crypto-wallets:

The term “review” as used herein refers to feedback or an evaluation provided by a user or customer of the wallet.

The term “user of the wallet” or “user of a wallet” as used herein refers to the “customers” or “users” who interact with or transact with the wallet by making payments to the wallet.

Certain embodiments generally provide a system and/or a method of determining a trustworthiness of a wallet, for example a crypto-wallet and certain kinds of digital wallets, for example closed digital wallets (such as Amazon Pay®). The determination may be in the form of a rating or ranking or otherwise. The wallet may be a custodial wallet (i.e. a wallet in which the private keys are held by a third party that has full control over the funds) or a non-custodial wallet.

As a result, instead of providing general business reviews of the business, certain embodiments are focused on the wallet of the business or of the organization. Instead of commenting on the business or organization in general and posting the comments or reviews when convenient, for example on a web site that advertises the business, the trustworthiness is what is reviewed and monitored and specifically the trustworthiness of the wallet of the business or organization is what is reviewed and monitored. Furthermore, in some embodiments the review is generated as part of and during the payment process and the trustworthiness determination is automatically determined as a result of the review or comment or feedback made during the payment process.

In certain embodiments, the review (and/or the trustworthiness rating or ranking based on the review(s)) is specifically related to a “payment aspect” of the business or organization (that owns the wallet) as opposed to an overall evaluation of the business or organization. For example, the review (or the trustworthiness determination) may be generated while the user is making (or is prompted to make) the payment to the business or organization using the wallet. Or the review (or the trustworthiness determination) may evaluate the payment policies and/or payment procedures of the business or organization. Or the review (or the trustworthiness determination) may express how reliable the business or organization is in regard to assuring that funds paid using the wallet result in receipt by the user of the goods or services promised to the user.

Moreover, the system and method herein may relate to the trustworthiness of a wallet used in a business or a wallet used for making payments to a charitable institution. Accordingly, anything stated below relating to a wallet of a for-profit business applies equally well to payments made to a not for profit or a nonprofit organization.

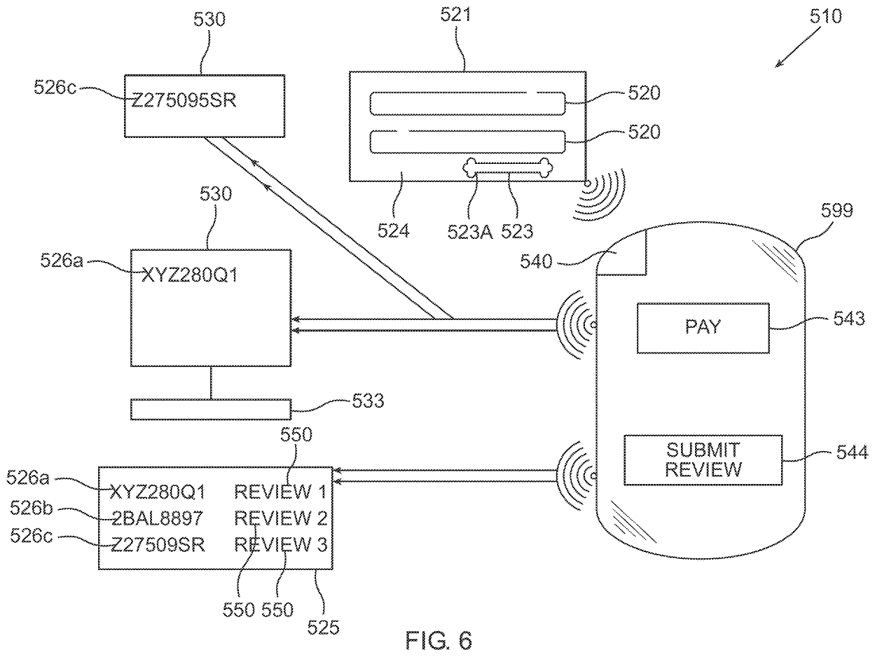

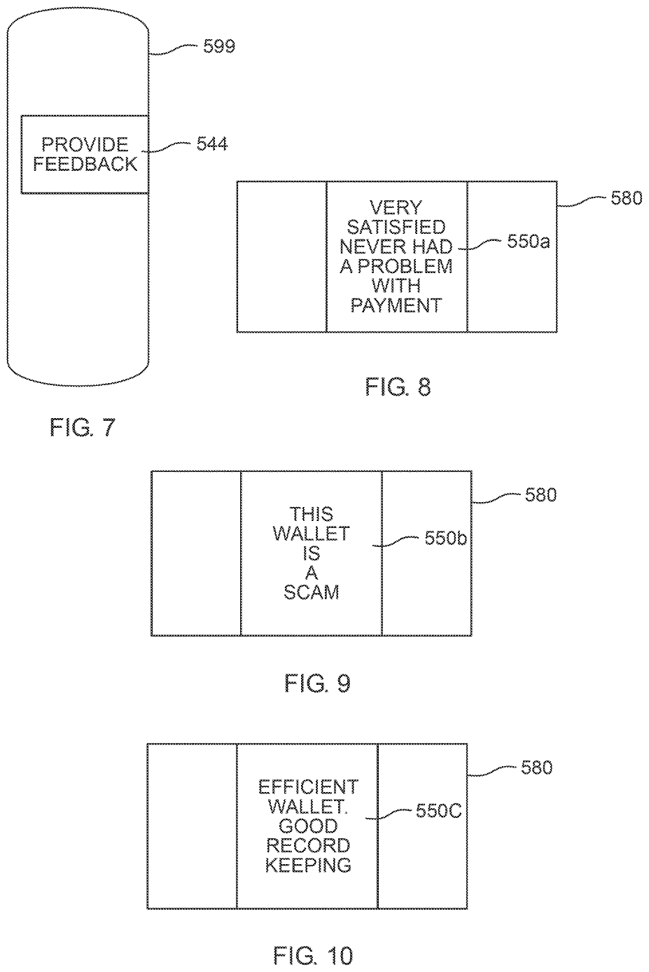

As shown in FIG. 6, a system 510 for ranking the trustworthiness of one or a plurality of wallets 530. The following description of system 510 applies to each wallet 530 of the one or the plurality of wallets 530.

The wallet 530 may have a public address. System 510 may include one or more processing units 521 each of which may include one or more processors 520. The one or more processors 520 are configured to execute software 523 or programming instructions or code that may be stored on a memory storage unit 524 of the one or more processing units 521.

In some embodiments, the wallet is a crypto-wallet configured for crypto-currency and is associated with a distributed ledger 533 such as blockchain. In that case, the reviews are recorded automatically in the distributed ledger 533 when they are created by the user who transacts with the wallet 530. In the case of a crypto-wallet, the wallet 530 contains, in encrypted form, all of the information necessary to access the wallet owner's funds on the blockchain 533 or on other distributed ledger 533.

In some embodiments, the wallet is a custodial wallet and in other embodiments the wallet is a non-custodial wallet.

In some embodiments, the wallet is a digital wallet and is not a crypto-wallet. In that case, the wallet is simply an online payment tool, usually in the form of an app. The digital wallet may securely store virtual versions of the user's debit and credit cards, so that the user does not need to enter the user's card details or carry a physical card to make payments

System 510 may also include-for each wallet 530 of one or a plurality of wallets 30-an application including a payment widget 540 that is configured to be downloadable to (or inherently built-in to) a mobile communication device 599 of the user (available to each user). The payment widget 540 is an Internet-based software application 523 (or a component made for a software platform) that provides an interactive virtual tool that allows a user of the wallet 530 (of the one or a plurality of wallets 530) to make a payment using the wallet 30 for example using a “Pay” tab 543 (FIG. 6).

As shown in FIG. 6, the payment widget 540 may be associated with the blockchain or other distributed ledger 533 in the case of a crypto-wallet 530 and, in the case of a closed digital wallet 530, the payment widget 540 may be associated with the payment network or gateway used such as Visa®, Mastercard® or Paypal®. The payment widget 540 may prompt users who interact with the wallet 530 to make a payment using the wallet 530. In addition, the payment widget 540 may be configured to prompt users of the wallet 530 to, during a transaction by the user that interacts with or utilizes the wallet 530 for payment, to input a review 550 of the wallet 530, for example using a “Submit Review” tab 544 or a “Provide Feedback” tab 544 or a similar prompt. The user device 599 is configured to then transmit that review to the database 25.

The payment widget 540 may operate in a mobile device environment (i.e. an environment of a mobile communication device 599 or a hybrid mobile device), or in other cases in a desktop environment. The payment widget may operate on any technological device such as a computer, cellular phone, smartphone, digital camera, video camera, audio recording device, or other electronic devices that can be used for creating, storing, or transmitting information in the form of electronic data including hybrid mobile devices that are used primarily for both computer functionality and also for communication purposes. The term “mobile communication device” includes mobile telephones, cellular telephones and smartphones.

The review promoted by the payment widget 540 may comprise an evaluation or may include feedback concerning a payment aspect of the business or organization that owns the wallet and to which the payments by the user are sent. The review may be addressed to one or more of the following issues: To what extent do you, the user, feel safe and secure making a payment to the owner of this wallet? To what extent do you feel safe paying through this wallet in that the funds will reach their destination and in that the funds will be exchanged for the promised goods or services promised and at the quality promised. Is this wallet a convenient way of paying? Is the wallet a safe way of transmitting the funds? Is the owner behind the wallet a reliable business or organization that provides the services or goods that they promise to provide? Is the owner of the wallet a scammer? Have you a lot of experience using this wallet? Have you had an overall positive or negative experience using this wallet? Is this wallet reliable at certain times but not others, or for payment for certain services but not others? Is this wallet a trustworthy way of paying? Does the wallet provide reliable accounting information in connection with the payment? How would you rate the trustworthiness of this wallet based on your experience? In certain embodiments, the user is prompted to input such a review or provide such feedback or comments during an actual transaction that utilizes the wallet. For example, during the transaction, the payment widget 540 may prompt the user to actuate an input that takes the user to a web site 580 where the user has an opportunity to input the review 550a, 550b, 550c (FIG. 8, FIG. 9, FIG. 10). The user may see a screen of the payment widget 540 on their mobile device (for example a smartphone) as shown in FIG. 2.

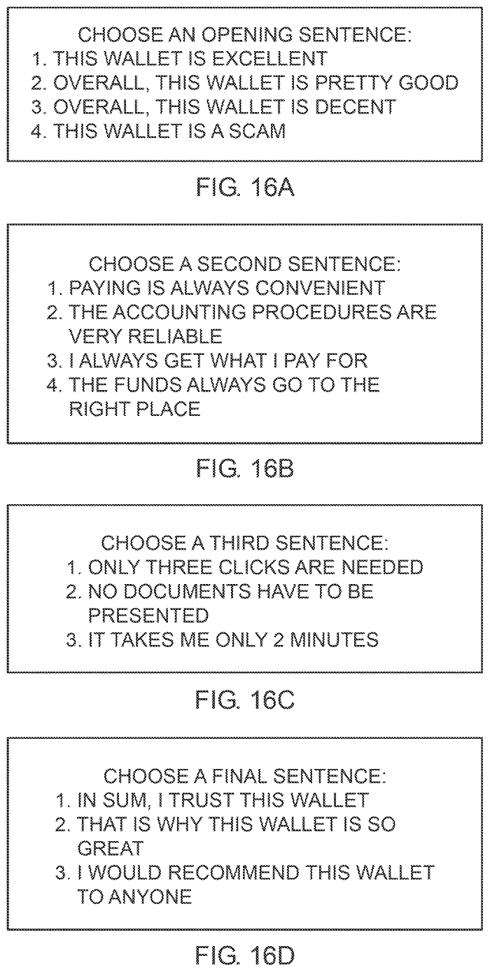

Applicant believes that the time it takes in providing a review is an important factor reducing the frequency with which users provide a review. Accordingly, in certain embodiments, software 523 includes artificial intelligence (AI) programming code, for example generative artificial intelligence programming code 523A (FIG. 6), that is used in prompting the user's review to streamline the process of providing feedback for the user. In one implementation, as shown in FIG. 16A, FIG. 16B, FIG. 16C and FIG. 16D, the AI proposes a choice between four first sentences of the review. In FIG. 16A, the different proposed opening sentences capture the overall positive or negative satisfaction of the user for the wallet, and the degree of such satisfaction. For example, as shown in FIG. 16A, one positive proposed first sentence may read “This wallet is excellent.” After the user selects from among the possible first sentences presented to him or her, the AI generates five different second sentences. The four proposed second sentences, as shown in FIG. 16B, provide different examples of what someone with that level of satisfaction expressed in the respective first sentence might say as the reason for such satisfaction or dissatisfaction. An example of a second sentence that dovetails with the first choice of a first sentence of FIG. 16A in the above example of a first sentence might be “Paying is always convenient”. As seen from FIG. 16C, based on the first and second sentences selected, the AI proposes three different third sentences each of which, like the second sentence, provides an example of a flaw or in this case a merit, to the wallet corresponding to that level of satisfaction. Finally, as seen from FIG. 16D, based on the first 3 sentences chosen by the user for the review, the AI generates a fourth and final sentence that concludes about how trustworthy or untrustworthy the wallet is while recapping the reasons. The above is only a non-limiting example of how the AI can be implemented. The number and type of questions are merely illustrative. Moreover, the user may also have the option of bypassing all proposals by the AI program and writing the user's review without assistance.

In some embodiments, where the wallet is a crypto-wallet, the review is then automatically recorded in a distributed ledger 533, such as a blockchain ledger. This recordation of the review on the distributed ledger 533 such as blockchain has the effect of making the review unchangeable.

In some embodiments, moreover, system 510 includes a protocol of the one or more processors to transmit certain transaction context to the distributed ledger 533 for recordation. The transaction context may be details of the transaction such as the item or service purchased. This is in contrast to the current protocol, wherein the distributed ledger only states that the party X paid the party Y the amount of Z cryptocurrency but the item or service purchased or other transaction context does not appear. Accordingly, in some embodiments, the one or more processors 520 and/or the payment widget 540 are configured to transmit to the distributed ledger some transaction context for recordation in the distributed ledger as a transaction receipt.

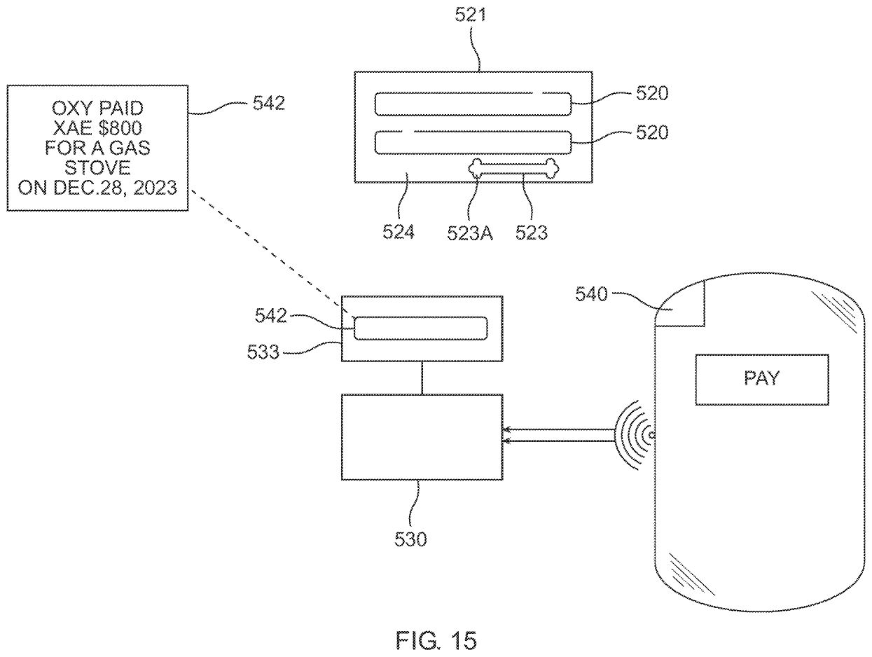

In some embodiments, as shown in FIG. 15, as soon as a payment is made by the buyer, for example using payment widget 540 appearing on the buyer's device 599, the payment widget 540 of system 510 may generate a transaction receipt 542 that may optionally also appear on a screen of a web site or on a mobile device of the seller (the owner of the wallet 530). Payment widget 540 may transmit the transaction receipt 542 to the distributed ledger 533. The one or more processors 520 may be configured to facilitate transmission of the receipt in the name of the seller who is the owner of the wallet 530 after the wallet 530 receives payment by the buyer (i.e. the user who transacts using the wallet 530) or alternatively after such payment is recorded in the distributed ledger 533. The one or more processors 520 may also facilitate the process by recording the transaction receipt 542 in the distributed ledger or may otherwise facilitate the process. The automatic issuance or generating on behalf of the seller of a transaction receipt 542 that is transmitted to and recorded in the distributed ledger 533 may serve to increase a trustworthiness of the seller's wallet 530. Typically, the buyer is also the user who provides a review of the wallet 530, whereas the wallet 530 may be “owned” or issued or provided by the seller.

The one or more processors 520 may be situated as a system server computer and may be associated with a web site. The one or more processors 520 may also include a processor inside a user device.

System 510 may also comprise a database 525 stored on memory storage unit 524 of the one or more processing units 521 and maintained by the one or more processors 520. For each of the one or the plurality of wallets 530, the one or more processors 520 may also be configured, for each of the users of the wallet, to receive and store in a database 525 maintained by the one or more processors 520, the reviews of the wallet by the users.

Each wallet 530 may be identified in the database 525 by a public address 526a, 526b, 526c (FIG. 6) of the wallet 30, which is, in one non-limiting example, a string of alphanumeric characters. In some other embodiments, the public address 526 of the wallet 530 is a permanent address that can be used for multiple transactions and is valid indefinitely, like a bank account.

In some other embodiments, the public address 526 of the wallet 530 is a temporary address generated for and usable for only one transaction. It may be randomly generated. If there are multiple public addresses, then each public address may appear in the database 525.

In some embodiments, for each of the one or the plurality of wallets 530, the one or more processors 520 are also configured to, for each of the users of (i.e. the users who interact with or transact with) such wallet 530, transmit to a device 599 of the user (for example a mobile device) a code or a prompt to have the user respond in a manner that verifies the authenticity of the user's review.

In one implementation, for each of the one or the plurality of wallets 30 the one or more processors 520 may also be configured to, for each of the users, transmit to a device 599 of a user (for example a mobile device of the user) who submits the user's review, a code, which may be uniquely associated or otherwise associated with the user, for use in verifying an authenticity of the review submitted by the user. In any embodiment herein, the authenticity of the review means the authenticity of the user having transacted business with the business or organization and/or the verification of the user's identity. In some embodiments, this would happen each time that user uses the wallet for a payment or each time the payment widget is used by the user.

In some embodiments, the code is as simple as a password or an alphanumeric string of characters. In some other embodiments, the code is a QR code, for example a QR code transmitted to a mobile device of the user from the business or organization (that owns the wallet). In some embodiments, the QR code is a dynamic QR code. In some cases, the dynamic QR code is time-stamped.

QR codes usually store web links but they can also store arbitrary data, such as text or images. In some embodiments, when the user scans the QR code with the user's device, such as a mobile device, the QR reader in the camera of the user's phone deciphers the code, and the resulting information triggers an action on the user's phone, thereby taking the user to the system web site at which the user is prompted to input a verification of the review.

The verification can take many different forms. The user can provide some details about the transaction that the user had with the business. In some embodiments, the QR code may have as an input a selfie of the user that the user may take of himself or herself using the user's device. The selfie can be a photo taken while the user is in the office of the owner of the wallet. In some cases, the selfie appears as part of the review recorded in a distributed ledger 533 (or in the case of a closed digital wallet, recorded in the records maintained by the digital wallet). The QR code may contain a web site address managed or operated by the one or more processors 520.

In some embodiments, the code is a QR code that has an image either embedded within the QR code or is configured to be received along with the QR code for display on a web page, for example a web page of a web site operated by the one or more processors.

For each of the one or the plurality of wallets 530, the one or more processors 520 may also be configured to set a value or a range of values of each stored review of the users in a series of transactions using the wallet 530. In some embodiments, the user is prompted to provide a numerical grade for the review. In one particular non-limiting example, the value of a particular review is implemented as a number representing a grade assigned to the trustworthiness of the wallet. For example, the grades may be excellent—1, good—2, average—3, mediocre—4 and poor—5.

In some embodiments, the user is not asked to provide a numerical grade for the user's review and instead a generative artificial intelligence program is configured to scan the words of the review and determine a numerical value of the review. In some embodiments, in the case of a review by a particular user that is not the first review by that particular user of the same wallet in question, the one or more processors are configured to present to the user an option to view previous reviews of the user of that wallet.

For each of the one or the plurality of wallets 530, the one or more processors 520 may also be configured to determine a ranking or rating of the trustworthiness of the wallet based on a function applied to the values of each of the stored reviews.

The function may be a weighted mathematical function. For example, the function may take into account the frequency that a particular level of rating occurs for the wallet. In some embodiments, the function attaches a weight to a value set for each review based on at least one of a frequency of that value.

For each of the one or the plurality of wallets 530, the one or more processors 520 may also be configured to update the trustworthiness determination each time a further review has been stored into the database 525 and a value has been set for this review. The update may involve determining, using the one or more processors, an updated ranking or rating of the trustworthiness of the wallet based on the mathematical function applied to values of each newly stored reviews.

After the review has been stored in the database 525, the review may be accessed by users. In some embodiments, the review is accessible only to users of the wallet who previously posted a review. In other embodiments, the review is accessible to all users of the wallet. In certain embodiments, the reviews are accessible to everyone. In some embodiments, the reviews are accessible to those who are members of a network associated with the system 510. In still other embodiments, the reviews are accessible to those who previously posted a review as well to other owners of a wallet.

In some embodiments, for each of the one or the plurality of wallets 530 the one or more processors 520 are also configured to traverse a chain of transactions of one particular user and set the value or range of values for each review of the wallet by that particular user, and determine a ranking or rating of the trustworthiness of the wallet based on the function applied to at least some of the values of each of the stored reviews by that particular user. Then after doing this for all the users, the one or more processors is configured to then determine an overall ranking or rating of the trustworthiness of the wallet based on the function by traversing all reviewed transactions (of the plurality of the particular users) that were recorded in the distributed ledger 533 associated with the wallet 530. Furthermore, the one or more processors would then update the determination of trustworthiness as further reviews by the particular user get stored in the database 525 and have a value set for them.

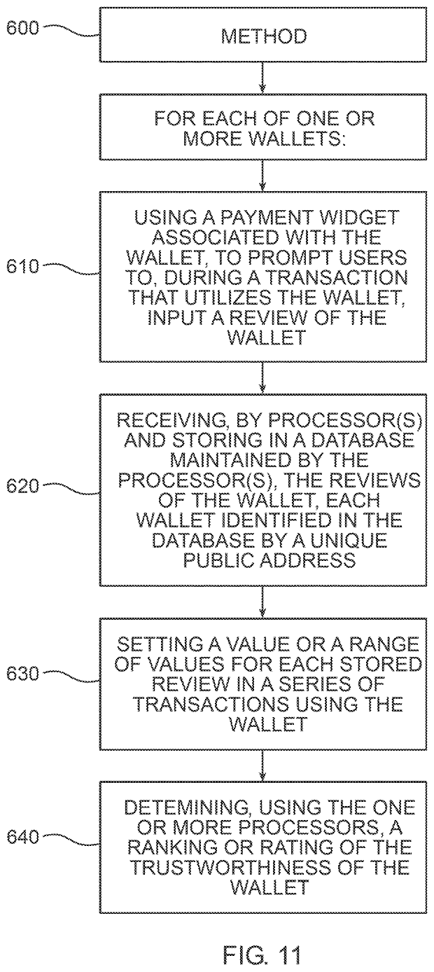

As shown in the flow chart of FIG. 11, another embodiment is a method 600 of ranking the trustworthiness of one or a plurality of wallets, for example each wallet being a wallet that is a digital wallet or a crypto-wallet. All of the details, versions and embodiments of the wallet described with respect to system 510 apply equally to the wallet utilized in the method 600 described herein.

The following steps of method 600 may be implemented for each wallet 530 of the one or a plurality of wallets 530, for each user who interacts/transacts with the wallet 530.

Method 600 may include a step 610 of using a payment widget 540 (that may be associated with the blockchain 533 or other distributed ledger 533 in the case of a crypto-wallet 530 and, in the case of a closed digital wallet 530, may be associated with the payment network or gateway used such as Visa®, Mastercard® or Paypal®) to prompt users of the wallet to, during a transaction that utilizes the wallet, input a review of the wallet 530. All of the details, versions and embodiments of the payment widget 540 described with respect to system 510 apply equally to the payment widget 540 utilized in the method 600 described herein (and in the other methods 700, 800, 900 described herein).

Method 600 may also comprise a step 620 of receiving, by one or more processors, and storing in a database 525 maintained by the one or more processors 520, the reviews of the wallet by the users, the wallet identified in the database 525 by a public address. If method 100 is performed for multiple wallets, then each wallet is identified in the database by its own public address (for example a unique public address). All of the details, versions and embodiments of the one or more processors 520 and what they are configured to do that were previously described with respect to system 510 apply equally to the one or more processors used in the methods 600, 700, 800, 900 described herein.

In some embodiments, the public address is a permanent public address. If in a particular embodiment the public address is a temporarily generated public address and there are more than one such public address then the database would identify all such public addresses of the wallet.

As with system 510, in some embodiments of method 600 (or of methods 700, 800, 900), where the wallet 530 is a crypto-wallet, the review may be automatically recorded in a distributed ledger 533, such as a blockchain ledger, which has the effect of making the review unchangeable.

In some embodiments, moreover, method 600 (or method 700, 800 or 900) includes a protocol of the one or more processors 520 and/or the payment widget 540 to generate or to facilitate issuance on behalf of a seller who owns the wallet 530 of a transaction receipt 542 that may be recorded in the distributed ledger 533. The transaction receipt 542 (FIG. 15) may include details of the transaction between the buyer, who interacted with wallet 30 of the seller, and the seller. The transaction details may include the item or service purchased, the names of the buyer and seller and the price paid and received.

Another step 630 that may be included in method 600 is setting, by the one or more processors, a value or a range of values of each stored review of the users in a series of transactions using the wallet.

Method 600 may also comprise a step 640 determining, using the one or more processors 525, a ranking or rating of the trustworthiness of the wallet. The determination may be made based on a function (i.e. a mathematical function) applied to the values of each of the stored reviews.

As further reviews get stored and a value gets set for them, the determination of the trustworthiness of the wallet 530 will automatically be updated. Accordingly, method 600 may also include a step of determining, using the one or more processors 525, an updated ranking or rating of the trustworthiness of the wallet based on the mathematical function applied to values of each newly stored reviews.

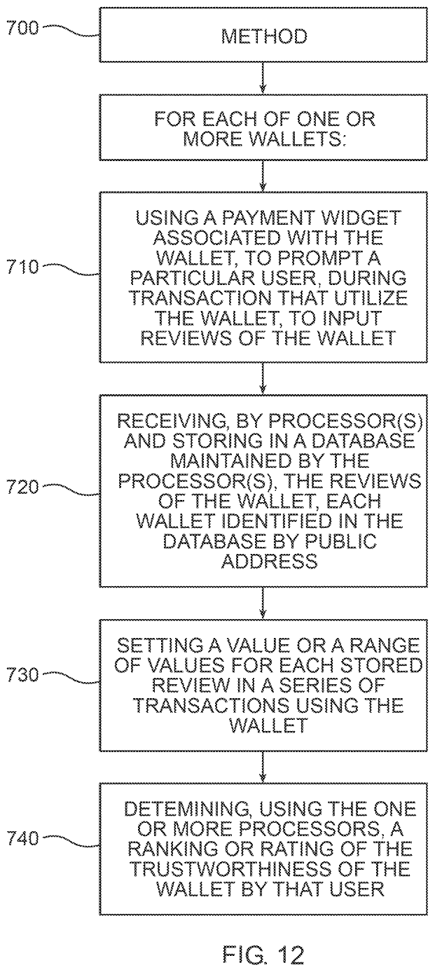

A further method 700 is shown in FIG. 12 relating to a particular user. The following steps of method 700 may be implemented for each wallet 530 of the one or a plurality of wallets 530, and for each user who interacts/transacts with the wallet 530.

Method step 710 may comprise using a payment widget configured to prompt users to make payments to the wallet, to prompt a particular user, during transactions that utilize the wallet, to input reviews of the wallet. As in system 510, in method 600 (and in methods 700, 800, 900), in the case of crypto-wallets, the payment widget 40 is associated with the blockchain or other distributed ledger 533 and in the case of a closed digital wallet, the payment widget 540 is associated with the payment network or gateway such as Visa®, Mastercard® or Paypal®.

Step 720 may include receiving, by processor(s) and storing in a database maintained by the processor(s), the reviews of the wallet, each wallet identified in the database by a public address. Step 730 may comprise setting a value or a range of values for each stored review in a series of transactions using the wallet. Step 740 may involve determining, using the one or more processors, a ranking or rating of the trustworthiness of the wallet by that particular user.

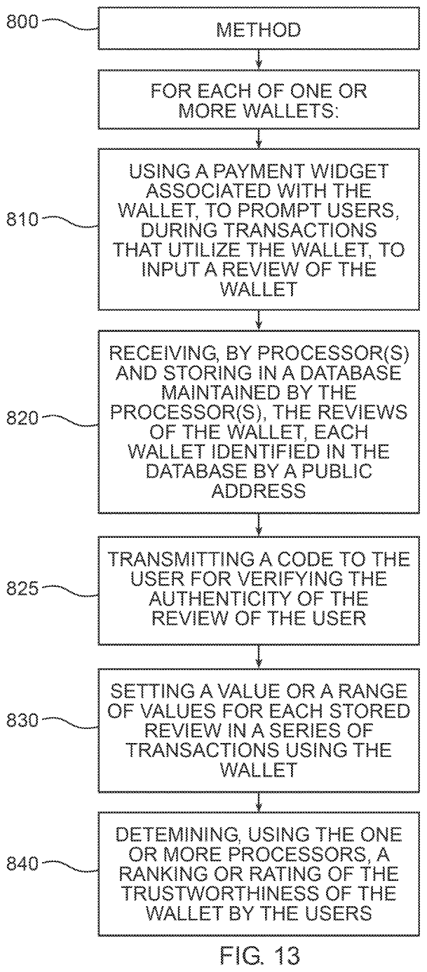

Another method 800 similar to method 600 (except that it includes the following additional step 825) is shown in the flow chart of FIG. 13. The steps of method 800 may be implemented for each wallet 530 of the one or a plurality of wallets 530, and for each user who interacts/transacts with the wallet 30.

In method 800 there is an additional step 825 of, for each of the users, transmitting, by the one or more processors, to a device of a user who submits the user's review, a code, for example a code that may be uniquely (or otherwise) associated with the user, for use in verifying an authenticity of the user's review, or a prompt to have the user verify the review in some other manner. For example, in the case of a code, such a code may be transmitted during the transaction in which the user/customer pays.

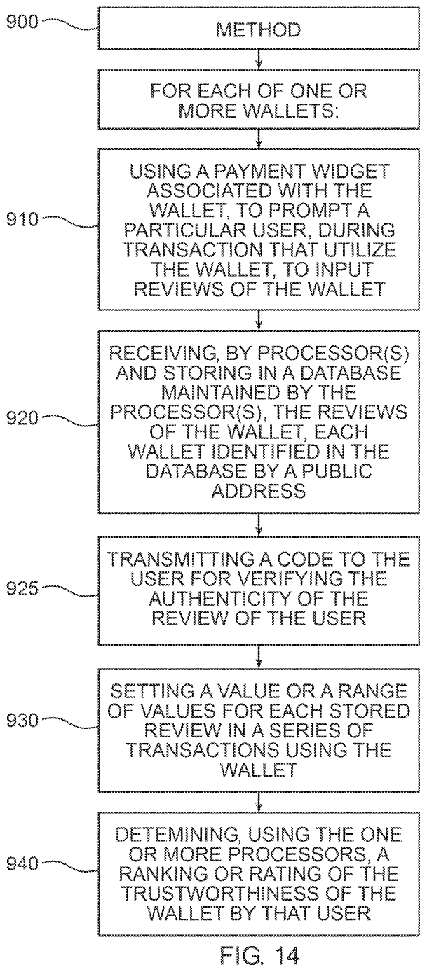

Another method 900 similar to method 700 (except that it includes the following additional step 925) is shown in the flow chart of FIG. 14. The steps of method 900 may be implemented for each wallet 530 of the one or a plurality of wallets 530, and for each user who interacts/transacts with the wallet 530. In method 900 there is an additional step 925 of transmitting, by the one or more processors, to a device of the particular user who submits the user's review, a code, for example a code that may be uniquely (or otherwise) associated with the particular user, for use in verifying an authenticity of the user's review, or a prompt to have the user verify the review in some other manner. For example, in the case of a code, such a code may be transmitted during the transaction in which the user/customer pays.

All of the details, versions, methods and embodiments of the payment code described with respect to system 510 apply equally to the wallet utilized in the methods 600, 700, 800, 900 described herein.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable (storage) medium(s) (for example memory 524) having computer readable program code 523 or programming instructions 523 embodied thereon. The storage medium may be a non-transitory computer readable storage medium.

While the invention has been described with respect to a limited number of embodiments, it will be appreciated that many variations, modifications and other applications of the invention may be made. Therefore, the claimed invention, as recited in the claims that follow, is not limited to the embodiments described herein.

What is claimed is:

1. A method of using bilateral ratings on distributed ledgers to establish reliable reputations and resolve disputes automatically, comprising:
for each purchase of goods or services, using a widget or a web site to allow a buyer and a seller to interact with one another by posting transactions on a distributed ledger, one or more of the transactions include deadlines relating to the purchase, for each purchase, one or more of: (A) using the widget or the web site to provide number-mappable ratings by the buyer of the seller and by the seller of the buyer regarding the purchase that are transmitted to the distributed ledger for storage thereon by (i) one or more processors and/or by (ii) the widget or the web site and (B) generating automated numerical ratings by the one or more processors based on the seller's and the buyer's compliance with the deadlines stated in the posted transactions, extracting, by an extraction program, the number-mappable ratings and/or the automated numerical ratings from multiple invoices on the distributed ledger, and using, by the one or more processors, the number-mappable ratings in aggregate and/or the automated numerical ratings in aggregate to generate overall current reputation ratings for the buyer and for the seller that are accessible by the widget or the web site and updateable after each purchase; and
upon a particular buyer or particular seller disputing an amount on the distributed ledger, quantitatively comparing, by the one or more processors, an overall current reputation rating of the particular buyer and of the particular seller, and generating, based on the quantitative comparison, an automated resolution of the amount by automatically recording on the distributed ledger an adjustment of a crypto-currency account of one or more of the particular buyer and the particular seller.

2. The method of claim 1, further comprising rewarding, by the one or more processors, the particular buyer with a higher share of the disputed amount than the particular seller if the particular buyer has a higher overall current reputation rating than the particular seller.

3. The method of claim 1, further comprising using, by the one or more processors, a ratio of (i) the overall current reputation rating of the particular buyer to (ii) the overall current reputation rating of the particular seller, to determine an amount of the adjustment.

4. The method of claim 1, further comprising adjusting upward, by the one or more processors, a portion of the amount disputed awarded to the seller or to the buyer based on the relative overall current reputation rating between the buyer and the seller.

5. The method of claim 1, further comprising for each purchase both (A) using the widget or the web site to provide number-mappable ratings by the buyer of the seller and by the seller of the buyer regarding the purchase that are transmitted to the distributed ledger for storage thereon by (i) the one or more processors or by (ii) the widget or the web site and (B) generating the automated numerical ratings by the one or more processors.

6. The method of claim 5, further comprising prompting the seller and/or the buyer to select whether the extraction program extracts the number-mappable ratings, the automated numerical ratings or both the number-mappable ratings and the automated numerical ratings.

7. The method of claim 5, further comprising extracting both the number-mappable ratings and the automated ratings and using the web site or the widget to display a version of the overall current reputation ratings of the buyer and/or seller based on the number-mappable ratings, a version based the automated ratings and a version based on both the number-mappable ratings and the automated ratings, wherein the buyer and/or the seller is prompted to select one of the three versions for purposes of the automated resolution of the amount in dispute.

8. The method of claim 1, wherein the one or more processors are configured to either (i) give less weight to number-mappable ratings of the buyer rating the seller as to a first purchase compared to the buyer rating the seller on a subsequent purchase or to (ii) give more weight to number-mappable ratings of the buyer rating the seller as to the first purchase compared to the buyer rating the seller on the subsequent purchase.

9. The method of claim 1, wherein the one or more processors are configured to either (i) give less weight to number-mappable ratings of the seller rating the buyer as to a first purchase compared to the seller rating the buyer on a subsequent purchase or to (ii) give more weight to number-mappable ratings of the seller rating the buyer as to the first purchase compared to the seller rating the buyer on the subsequent purchase.

10. The method of claim 1, wherein the automated numerical ratings of the seller are also based on whether and how soon the buyer accepted the goods or services.

11. The method of claim 1, further comprising storing, by (i) the one or more processors and/or (ii) the widget or the web site, on the distributed ledger by invoice ID a purchase price and description of the purchased goods or services and the identity of the buyer and the seller.

12. The method of claim 1, wherein a text of the buyer's rating of the seller is recorded for the purchase on the distributed ledger along with the number-mappable rating.

13. The method of claim 12, wherein the widget or the extraction program is configured to retrieve the text from the distributed ledger and display it on the widget or web site.

14. The method of claim 1, further comprising automatically escrowing, by the one or more processors, funds of the buyer in an amount of a price of the purchase on the distributed ledger pending delivery by the seller.

15. The method of claim 1, wherein if the buyer or the seller lodge a dispute of the purchase, the one or more processors automatically penalize both the buyer and the seller in future calculations of one or both of automated numerical ratings and the overall current reputation ratings.

16. The method of claim 1, further comprising using the widget or a web site controlled by the one or more processors, the web site interacting with the distributed ledger, to post a confirmation on the distributed ledger of one or more of the following:
(a) the seller presents the buyer with an invoice including a timeframe for the buyer to approve delivery, and including a negotiation timeframe, wherein the buyer inputting approval on the widget or the web site triggers the one or more processors to record and hold an amount of the purchase price in crypto-currency in escrow on the distributed ledger pending the seller posting that delivery occurred,
(b) the seller declares delivery, failure of which results in reversal of the amount of the escrowed crypto-currency funds and the overall current reputation rating of the seller automatically reduced for inability to deliver on time,
(c) the seller requests a specific amount of more time to deliver, failure of which by the buyer to approve results in a resolution similar to the seller's failure to deliver
(d) the buyer has a duration of the negotiation timeframe to accept delivery or if the buyer finds the deliverables to be inadequate,
(e) if the buyer does not respond to the delivery within the negotiation timeframe, the one or more processors mark the invoice as delivered on the distributed ledger and the amount held in escrow is released to the seller.

17. The method of claim 1, further comprising reducing, by the one or more processors, the overall current reputation rating of the buyer if the buyer does not respond to the delivery within the negotiation timeframe.

18. A system of using bilateral ratings of buyers and sellers on distributed ledgers to establish reliable reputations and resolve disputes automatically, comprising:
a widget or a web site configured, for each purchase of goods or services, to assist a buyer and a seller to interact with one another by posting transactions on a distributed ledger, one or more of the transactions include deadlines relating to the purchase;
one or both of: (A) the widget or the web site configured to prompt the buyer to input number-mappable ratings of the seller regarding the purchase and to prompt the seller to input number-mappable ratings of the buyer regarding the purchase, wherein (i) one or more processors and/or (ii) the widget or the web site, are configured to transmit to the distributed ledger for storage thereon the number-mappable ratings, and (B) the one or more processors configured to generate automated numerical ratings of the seller's and the buyer's compliance with deadlines stated in the transactions of the purchase,
an extraction program configured to extract the number-mappable ratings and/or the automated numerical ratings from multiple invoices on the distributed ledger, the one or more processors configured to:
(A) use the extracted number-mappable ratings in aggregate and/or the automated numerical ratings in aggregate to generate overall current reputation ratings for the buyer and for the seller that are updateable after each purchase and accessible by the widget or the web site; and
(B) upon a particular buyer or particular seller disputing an amount on the distributed ledger, quantitatively compare an overall current reputation rating of the particular buyer and of the particular seller, and generate based on the quantitative comparison an automated resolution of the amount by automatically recording on the distributed ledger an adjustment of a crypto-currency account of one or more of the particular buyer and the particular seller.

19. The system of claim 18, wherein the one or more processors are configured to reward the particular buyer with a higher share of the disputed amount than the particular seller if the particular buyer has a higher overall current reputation rating than the particular seller.

20. The system of claim 18, wherein the one or more processors are configured to use a ratio of (i) the overall current reputation rating of the particular buyer to (ii) the overall current reputation rating of the particular seller to determine an amount of the adjustment.
